(19) United States
(12) Patent Application Publication
(10) Pub. No.: US 2024/0041060 A1
(43) Pub. Date: Feb. 8, 2024

(54) COMPOSITION CONTAINING ALLULOSE AND METHODS OF USE

(71) Applicant: CJ CHEILJEDANG CORPORATION, Seoul (KR)

(72) Inventors: Youn-Kyung BAK, Suwon-si (KR); Sung Bae BYUN, Sejong (KR); Jong Min CHOI, Suwon-si (KR); Dong Chul JUNG, Seoul (KR); Su-Jeong KIM, Suwon-si (KR); Ji Hoon KOH, Seoul (KR); In LEE, Suwon-si (KR); Jung Gyu PARK, Incheon (KR); Seung Won PARK, Yongin-si (KR); Dong Seok SHIM, Yongin-si (KR)

(73) Assignee: CJ CHEILJEDANG CORPORATION, Seoul (KR)

(21) Appl. No.: 18/481,926

(22) Filed: Oct. 5, 2023

Related U.S. Application Data
(63) Continuation-in-part of application No. 16/467,090, filed on Jun. 6, 2019, now Pat. No. 11,812,769.
Application No. 16/467,090 is a continuation-in-part of application No. 16/078,607, filed on Aug. 21, 2018.
Application No. 16/078,607 is a continuation-in-part of application No. 16/340,129, filed on Apr. 7, 2019.
Application No. 16/340,129 is a continuation-in-part of application No. 16/348,869, filed on May 10, 2019.

(30) Foreign Application Priority Data
Mar. 9, 2016 (KR) 10-2016-0028514
Oct. 7, 2016 (KR) 10-2016-0130096
Dec. 9, 2016 (KR) 10-2016-0167707
Dec. 21, 2016 (KR) 10-2016-0175262

(51) Int. Cl. A23C 9/13; A23L 2/60; A23L 29/30

(52) U.S. Cl. CPC A23C 9/1307; A23L 2/60; A23L 29/30

(57) ABSTRACT

The present application relates to an amino acid beverage containing allulose; a sweetener including an oligosaccharide having increased acid resistance, a food including the same; an aerated water comprising allulose; fermented milk comprising saccharides comprising high content of allulose; and method of making and use thereof.

### CROSS-REFERENCE TO RELATED APPLICATIONS

This application claims the benefit of U.S. patent application Ser. No. 16/467,090 filed on Jun. 6, 2019 and published as U.S. Patent Application Publication No. 2019/0313668 (a national stage application of PCT/KR2017/015146 filed on Dec. 20, 2017, claiming priority to KR10-2016-0175262 filed on Dec. 21, 2016); Ser. No. 16/078,607 filed on Aug. 21, 2018 and published as U.S. Patent Application Publication No. 2019/0059428 (a national stage application of PCT/KR2017/002601 filed on Mar. 9, 2017, claiming priority to KR10-2016-0028514 filed on Mar. 9, 2016); Ser. No. 16/340,129 filed on Apr. 7, 2019 and published as U.S. Patent Application Publication No. 2019/0239539 (a national stage application of PCT/KR2017/010721 filed on Sep. 27, 2017, claiming priority to KR10-2016-0130096 filed on Oct. 7, 2016); and Ser. No. 16/348,869 filed on May 10, 2019 and published as U.S. Patent Application Publication No. 2019/0281848 (a national stage application of PCT/KR2017/014061 filed on Dec. 4, 2017, claiming priority to KR10-2016-0167707 filed on Dec. 9, 2016), each of which is incorporated herein in its entirety by reference.

### TECHNICAL FIELD

### Background

Allulose, which is a C-3 epimer of D-fructose, is a natural monosaccharide existing only in a trace amount in dry raisin, fig, wheat, and the like. A degree of sweetness of allulose is about 70% of a degree of sweetness of sugar, but allulose has a caloric content of about 0.2 kcal/g, which is about 5% of a caloric content of sugar (4 kcal/g), such that allulose has been spotlighted as a raw material of a sweetener capable of replacing sugar, and has been applied to lactic acid bacteria-fermented products.

### SUMMARY

The present application relates to an amino acid beverage containing allulose.

The present application also relates to a sweetener including an oligosaccharide having increased acid resistance, a food including the same, and a method of increasing acid resistance of an oligosaccharide.

The present application also relates to an aerated water comprising allulose and a method of preparing the same.

The present application also relates to fermented milk comprising saccharides comprising high content of allulose, and a method of improving storability of fermented milk using the saccharides.

### BRIEF DESCRIPTION OF DRAWINGS

FIG. 1 is a graph depicting initial carbon dioxide pressure values of aerated water samples prepared in Examples and Comparative Examples. Herein, * indicates an aerated water sample of Examples having a significant difference from a corresponding aerated water sample of Comparative Examples (statistical analysis: T-test group comparison, *p<0.05).

FIGS. 2 to 7 are graphs depicting time-dependent carbon dioxide pressure retention rate of aerated water samples prepared in Examples and Comparative Examples (statistical analysis: T-test group comparison, *p<0.05).

FIG. 8 is a graph illustrating a change in pH during cold-storage of fermented milk according to an exemplary embodiment of the present invention.

FIG. 9 is a graph illustrating a change in acidity during cold-storage of fermented milk according to an exemplary embodiment of the present invention.

FIG. 10 is a graph illustrating a change in sourness during cold-storage of fermented milk according to an exemplary embodiment of the present invention.

FIG. 11 is a graph illustrating a change in the number of lactic acid bacteria during cold-storage of fermented milk according to an exemplary embodiment of the present invention.

### DETAILED DESCRIPTION

Hereinafter, the present application will be described in more detail.

Meanwhile, the respective explanations and embodiments disclosed in the present application can also be applied to other explanations and embodiments. That is, all combinations of various elements disclosed in this application fall within the scope of the present application. In addition, it could not be said that the scope of the present application is limited by the specific description to be described below.

In addition, those skilled in the art will recognize and confirm many equivalents to specific aspects of the present application described in this application by using only routine experimentation. Such equivalents are also intended to be included in the present application.

One aspect of the present application provides a beverage comprising water, an amino acid, and allulose.

Another aspect of the present application provides a method for reducing an off-taste, an off-odor, or an acrid taste of a beverage containing an amino acid, comprising a step of mixing water, the amino acid, and allulose.

According to an aspect of the present application, there is provided a beverage including water, an amino acid, and allulose.

The water of the present application is not limited as long as it is water suitable for the preparation of common beverages, and may be, but not limited to, purified water, clean water, ground water, ion-containing drinking water, or a natural beverage, for example. The purified water includes all purified water such as purified water purified by ionization or filtration of general tap water or ground water, and the natural beverage is meant to include natural mineral water and artificial mineral water.

The amino acid of the present application may include both non-essential amino acids which are present in nature and can be synthesized in the human body, and essential amino acids which cannot be synthesized in the human body. Specifically, the amino acid of the present application may be one or more amino acids selected from the group consisting of L-arginine, L-methionine, L-ornithine, and L-citrulline.

In the present application, allulose is a type of saccharides having the formula C₆H₁₂O₆, the molecular weight of 180.16, is known to exist in small amounts in figs, grapes, and the like, and is also called psicose. The allulose is a concept including both D-allulose and L-allulose, and may be, but not limited to, one commercially available, one extracted directly from natural products, one chemically synthesized, or one prepared by biological methods. In addition, the allulose may be provided in solid or powder form, or as a liquid (i.e., syrup) containing the allulose. Specifically, the allulose of the present application may be a liquid allulose. The liquid allulose may contain the allulose in an amount of 10 to 99 parts by weight based on 100 parts by weight of dry solids (ds or DS).

In the beverage of the present application, the allulose may be contained in an amount of 3 to 11 parts by weight based on 100 parts by weight of the beverage, based on dry solids. Specifically, the allulose may be contained in an amount of 3 to 10 parts by weight, 3 to 9 parts by weight, 3 to 5 parts by weight, 4 to 11 parts by weight, 4 to 10 parts by weight, 4 to 9 parts by weight, 4 to 5 parts by weight, 5 to 11 parts by weight, 5 to 10 parts by weight, or 5 to 9 parts by weight, based on 100 parts by weight of the beverage, based on dry solids.

In the beverage of the present application, the amino acid and the allulose may be contained at a ratio of 1:30 to 1:110, based on dry solids weight. Specifically, the ratio may be 1:30 to 1:100, 1:30 to 1:90, 1:30 to 1:50, 1:40 to 1:110, 1:40 to 1:100, 1:40 to 1:90, 1:40 to 1:50, 1:50 to 1:110, 1:50 to 1:100, or 1:50 to 1:90.

As an embodiment, the beverage of the present application may further comprise one or more selected from the group consisting of sodium chloride, an organic acid, a high intensity sweetener, a flavoring, and a plant concentrate.

The sodium chloride may be natural or synthetic, provided that it can be used in beverages. Specifically, it may be a natural salt or a refined salt. Specifically, the sodium chloride may be contained in an amount of 0.01 weight % to 0.5 weight % or 0.05 weight % to 0.3 weight % based on the beverage weight.

The organic acid may be, for example, at least one organic acid selected from the group consisting of citric acid, lactic acid, acetic acid, fumaric acid, ascorbic acid and tartaric acid, or a salt thereof. Specifically, the organic acid may be contained in an amount of 0.01 weight % to 0.5 weight % or 0.1 weight % to 0.3 weight % based on the beverage weight.

The sodium chloride or organic acid may be in a solid, powder, or solution form.

The high intensity sweetener means a sweetener having the sweetness ten times or more higher than that of sucrose, and may be aspartame, acesulfame K, sucralose, rebaudioside-A, and the like. Specifically, the high intensity sweetener may be contained in an amount of 0.001 weight % to 0.025 weight % or 0.001 weight % to 0.01 weight % based on the beverage weight.

The flavoring may be, for example, a natural flavoring or a synthetic flavoring. Examples of the natural flavoring includes substances containing flavorings prepared from plant materials (that is, fruits, vegetables, medicinal plants, and the like) by conventional methods. Such natural flavorings may include components separated by steam distillation method, compression method, juice extraction method, extraction method, and the like, of natural materials. The flavoring may include one or more selected from flavors of materials, such as coffee flavor, black tea flavor, green tea flavor, oolong tea flavor, cocoa flavor, herb flavor, fruit flavor, lime flavor, grape flavor, apple flavor, lemon flavor, strawberry flavor, raspberry flavor, corn flavor, orange flavor, kumquat flavor, tangerine flavor, cinnamon flavor, grapefruit flavor, peach flavor, apricot flavor, pear flavor, apple flavor, pineapple flavor, cranberry flavor, blackberry flavor, schizandra flavor, box thorn flavor, blueberry flavor, black currant flavor, pomegranate flavor, acai berry flavor, banana flavor, mango flavor, guava flavor, watermelon flavor, dragon fruit flavor, durian flavor, melon flavor, Japanese apricot flavor, kiwi flavor, plum flavor, prune flavor, aronia flavor, papaya flavor, radish flavor, green pepper flavor, sweet pepper flavor, watercress flavor, parsley flavor, cauliflower flavor, cabbage flavor, Brussels sprout flavor, cabbage flavor, kale flavor, Angelica utilis flavor, spinach flavor, red beet flavor, broccoli flavor, pumpkin flavor, celery flavor, cabbage flavor, lettuce flavor, tomato flavor, carrot flavor, Welsh onion flavor, onion flavor, chives flavor, red pepper flavor, aloe flavor, cactus flavor, fatsia shoot flavor, elk clover flavor, dandelion flavor, Chinese yam flavor, ginger flavor, cornus fruit flavor, Caragana sinica flavor, Japanese lady bell flavor, mushroom flavor, balloon flower root flavor, Codonopsis lanceolata flavor, Hovenia dulcis flavor, arrow-root flavor, red ginseng flavor, ginseng flavor, cloudy flavor, and the like. Specifically, the flavoring may be contained in an amount of 0.01 weight % to 0.5 weight % or 0.1 weight % to 0.3 weight % based on the beverage weight.

The plant concentrate means a resulting product concentrated from fruits, vegetables, medicinal plants, or the rest plant materials by conventional methods. Specifically, the plant may be the material used for the flavoring. More specifically, the plant concentrate may be contained in an amount of 0.01 weight % to 0.5 weight % or 0.1 weight % to 0.3 weight % based on the beverage weight.

The beverage of the present application may further include fructose in an amount of 0.6 parts by weight or less based on 100 parts by weight of the beverage, based on dry solids. Specifically, the beverage of the present application may include fructose in an amount of 0.15 to 0.6 parts by weight, 0.2 to 0.6 parts by weight, 0.4 to 0.6 parts by weight, 0.15 to 0.4 parts by weight, or 0.2 to 0.4 parts by weight, based on 100 parts by weight of the beverage, based on dry solids.

In another embodiment, the beverage of the present application may not include glucose, sucrose, or the combination thereof.

In another embodiment, the pH of the beverage of the present application may be in a range of 3.0 to 5.0. Specifically, the pH may be in a range of 3.3 to 4.8, 3.5 to 4.7, or 3.6 to 4.6.

In other embodiments, the acidity of the beverage of the present application may be in a range of 0.05 to 0.2. Specifically, the acidity may be in a range of 0.1 to 0.15, or 0.110 to 0.146. In addition, the acidity may be a titratable acidity calculated by [Equation 1] below.

Acidity=0.6404*NaOH titer (V)/sample weight (s) [Equation 1]
(wherein *0.6404 is the amount (g) of citric acid corresponding to 1 mL of 0.1N—NaOH)

In addition, the beverage of the present application may further include food ingredients other than the ingredients described above (for example, flavorings, colorants, pectic acid and salts thereof, alginic acid and salts thereof, pH adjusters, glycerin, carbonating agents, preservatives, stabilizers, antioxidants, vitamins, minerals, proteins, and electrolytes, and the like).

Another aspect of the present application provides a method for reducing an off-taste, an off-odor, or an acrid taste of a beverage containing an amino acid, comprising a step of mixing water, the amino acid, and allulose.

The term “acrid taste (acridity)” as used in the present application refers to a pungent taste that irritates a throat.

In an embodiment of the reduction method of the present application, the allulose may be mixed in an amount of 3 to 11 parts by weight based on 100 parts by weight of the beverage, based on dry solids. Specifically, the allulose may be mixed in an amount of 3 to 10 parts by weight, 3 to 9 parts by weight, 3 to 5 parts by weight, 4 to 11 parts by weight, 4 to 10 parts by weight, 4 to 9 parts by weight, 4 to 5 parts by weight, 5 to 11 parts by weight, 5 to 10 parts by weight, or 5 to 9 parts by weight, based on 100 parts by weight of the beverage, based on dry solids.

In an embodiment of the reduction method of the present application, the amino acid and the allulose may be mixed at a ratio of 1:30 to 1:110, based on dry solids weight. Specifically, the ratio may be 1:30 to 1:100, 1:30 to 1:90, 1:30 to 1:50, 1:40 to 1:110, 1:40 to 1:100, 1:40 to 1:90, 1:40 to 1:50, 1:50 to 1:110, 1:50 to 1:100, or 1:50 to 1:90.

In addition, in an embodiment of the reduction method of the present application, one or more selected from the group consisting of sodium chloride, a high intensity sweetener, an organic acid, a plant concentrate, and a flavoring, may be further mixed in the step of mixing.

In another embodiment, the reduction method of the present application may not include a step of mixing one or more saccharides selected from the group consisting of glucose, sucrose, or the combination thereof.

In another embodiment, the reduction method of the present application may further include a step of heating between 85° C. and 105° C., after the step of mixing. Specifically, the heating may be carried out between 90° C. and 105° C., between 95° C. and 105° C., or between 90° C. and 100° C.

In addition, in another embodiment, the reduction of the present application may further include a step of cooling, after the step of heating. Specifically, the cooling may be carried out at 25° C. or less, between 1 and 25° C., between 1° C. and 10° C., or between 5° C. and 10° C.

In the method for reducing the off-taste, the off-odor, or the acrid taste of the present application, the contents overlapping with those described in the beverage of the present application (for example, water, amino acids, allulose, and the like) are the same as those described in the beverage, and thus, the description thereof is omitted in order to avoid the excessive complexity of this specification.

The amino acid beverage of the present application includes allulose, thereby reducing the off-taste, the off-odor, and the acrid taste resulting from the amino acid, and remarkably enhancing preferences of consumers. In addition, since the contained allulose has almost no calories, the amino acid beverage of the present application meets the essential health directionality of amino acid beverages.

In one aspect, there is provided a sweetener including allulose and an oligosaccharide, wherein the oligosaccharide has an increase in acid resistance.

As used herein, the term “allulose” refers to a C-3 epimer of fructose, which is a kind of ketohexose, a monosaccharide (C6).

As used herein, the term “oligosaccharide” refers to a saccharide polymer generally including 2 to 10 monosaccharides, and examples of the oligosaccharide may include fructooligosaccharide, isomaltooligosaccharide, galactooligosaccharide, xylooligosaccharide, maltooligosaccharide, and gentiooligosaccharide, without being limited thereto. Specifically, the oligosaccharide according to the present application may be fructooligosaccharide or isomaltooligosaccharide, more specifically fructooligosaccharide.

As used herein, the term “acid resistance” refers to stability against acid, specifically, resistance of oligosaccharide to deterioration in inherent properties due to acid. The sweetener according to the present application may have acid resistance at pH 1 to 6, specifically, at pH 2 to 6.

The sweetener according to the present application may have 90 wt % or more oligosaccharide, specifically 90 wt % to 99 wt %, 90 wt % to 95 wt %, or 90.3 wt % to 92.8 wt % as measured after 24 hours of storage at pH 2, based on oligosaccharide weight at 0 hours of storage under the same conditions.

In addition, the sweetener may have 80 wt % or more oligosaccharide, specifically 80 wt % to 99 wt %, 80 wt % to 95 wt %, 80 wt % to 90 wt %, or 82.9 wt % to 86.2 wt %, as measured after 48 hours of storage at pH 2, based on oligosaccharide weight at 0 hours of storage under the same conditions.

In the sweetener according to the present application, the oligosaccharide may have improved heat resistance.

As used herein, the term “heat resistance” refers to stability against heat, specifically, resistance of the oligosaccharide to deterioration in inherent properties due to heat. The sweetener according to the present application may have heat resistance at a temperature of 20° C. to 90° C. Specifically, the sweetener may have heat resistance at a temperature of 20° C. to 85° C., 25° C. to 90° C., 25° C. to 85° C., 50° C. to 90° C., 50° C. to 85° C., 80° C. to 90° C., 80° C. to 85° C., or 85° C.

The sweetener according to the present application may have 30 wt % or more oligosaccharide, specifically 50 wt % or more, 60 wt % or more, 30 wt % to 95 wt %, 30 wt % to 90 wt %, 30 wt % to 85 wt %, 50 wt % to 95 wt %, 50 wt % to 90 wt %, 50 wt % to 85 wt %, 60 wt % to 95 wt %, 60 wt % to 90 wt %, 60 wt % to 85 wt %, or 62.8 wt % to 81.2 wt % oligosaccharide, as measured after 2 hours of storage under conditions of pH 2 and 85° C., based on oligosaccharide weight at 0 hours of storage under the same conditions.

In addition, the sweetener according to the present application may have 10 wt % or more oligosaccharide, specifically 30 wt % or more, 50 wt % or more, 10 wt % to 95 wt %, 10 wt % to 90 wt %, 10 wt % to 80 wt %, 10 wt % to 70 wt %, 30 wt % to 95 wt %, 30 wt % to 90 wt %, 30 wt % to 80 wt %, 30 wt % to 70 wt %, 50 wt % to 95 wt %, 50 wt % to 90 wt %, 50 wt % to 80 wt %, 50 wt % to 70 wt %, or 51.2 wt % to 66.6 wt % oligosaccharide, as measured after 4 hours of storage under conditions of pH 2 and 85° C., based on oligosaccharide weight at 0 hours of storage under the same conditions.

In the sweetener according to the present application, the allulose may be present in an amount of 20 parts by weight to 1000 parts by weight, specifically 30 parts by weight to 1000 parts by weight, 40 parts by weight to 1000 parts by weight, 45 parts by weight to 1000 parts by weight, 30 parts by weight to 900 parts by weight, 40 parts by weight to 900 parts by weight, 45 parts by weight to 900 parts by weight, 30 parts by weight to 800 parts by weight, 40 parts by weight to 800 parts by weight, 45 parts by weight to 800 parts by weight, 30 parts by weight to 750 parts by weight, 40 parts by weight to 750 parts by weight, or 45 parts by weight to 750 parts by weight, relative to 100 parts by weight of the oligosaccharide.

The sweetener according to the present application may be improved in taste. Specifically, the sweetener according to the present application may be improved in sweetness.

The sweetener according to the present application may further include a salt. The salt may include citrates, lactates, carbonates, phosphates, or combinations thereof. Specifically, the salt may be calcium citrate, potassium citrate, sodium citrate, potassium lactate, calcium lactate, sodium lactate, calcium carbonate, potassium carbonate, potassium hydrogen carbonate, sodium carbonate, sodium hydrogen carbonate, monopotassium phosphate, dipotassium phosphate, tripotassium phosphate, calcium hydrogen phosphate, calcium dihydrogen phosphate, tricalcium phosphate, monosodium phosphate, disodium phosphate, trisodium phosphate, or a combination thereof, more specifically sodium citrate, sodium lactate, sodium hydrogen carbonate, or trisodium phosphate.

The salt may be present in an amount of 0.05 parts by weight to 0.5 parts by weight relative to 100 parts by weight of the sweetener. Specifically, the salt may be present in an amount of 0.1 parts by weight to 0.5 parts by weight or 0.1 parts by weight to 0.3 parts by weight relative to 100 parts by weight of the sweetener.

The sweetener according to the present application may be a liquid sweetener, a powdery sweetener, or a granular sweetener, without being limited thereto.

The sweetener according to the present application may further include a sweetening agent other than the oligosaccharide and the allulose, a synthetic preservative, a natural preservative, or a combination thereof. Examples of the sweetening agent other than the oligosaccharide and the allulose may include glucose, fructose, lactose, maltose, sugar, corn syrup, sugar syrup, oligosaccharides, tagatose, xylose, honey, high sweetening agents (for example, steviol glycoside, sucralose, aspartame, acesulfame potassium, saccharin sodium, and the like), dietary fiber, and dextrin, without being limited thereto. Examples of the synthetic preservative may include potassium sorbate, calcium sorbate, sorbic acid, sodium benzoate, benzoic acid, potassium benzoate, calcium benzoate, methyl p-oxybenzoate, and ethyl p-oxybenzoate, without being limited thereto. Examples of the natural preservative may include grapefruit seed extract, citrus extract, complex gold extract, lactic acid bacterium complex powder, and polylysine, without being limited thereto.

In accordance with another aspect of the present application, there is provided a method of increasing acid resistance of an oligosaccharide of an oligosaccharide-containing sweetener which includes applying allulose to the oligosaccharide. As used herein, the term “applying” includes mixing, adding, coating, and spraying, without being limited thereto. Specifically, the applying may be mixing or adding.

Herein, mcrease m acid resistance means that the weight of the oligosaccharide measured after the allulose is applied to the oligosaccharide, followed by standing at pH 2 for 24 hours or 48 hours, is increased by 5 wt % or more, 7 wt % or more, 10 wt % or more, or 13 wt % or more, as compared with the weight of the oligosaccharide measured after the oligosaccharide is allowed to stand under the same conditions as above without applying the allulose to the oligosaccharide.

In the method of increasing acid resistance of the oligosaccharide, heat resistance of the oligosaccharide may also be increased.

In the method of increasing acid resistance and heat resistance of the oligosaccharide, increase in acid resistance and heat resistance means that the weight of the oligosaccharide measured after the allulose is applied to the oligosaccharide, followed by standing at pH 2 and 85° C. for 2 hours or 4 hours, is increased by 10 wt % or more, 20 wt % or more, 30 wt % or more, 40 wt % or more, 50 wt % or more, 60 wt % or more, 70 wt % or more, 80 wt % or more, or 90 wt % or more, as compared with the weight of the oligosaccharide measured after the oligosaccharide is allowed to stand under the same conditions as above without applying the allulose to the oligosaccharide.

In the method according to the present application, the allulose may be applied in an amount of 20 parts by weight to 1,000 parts by weight relative to 100 parts by weight of the oligosaccharide. Specifically, the allulose may be added in an amount of 30 parts by weight to 1,000 parts by weight, 40 parts by weight to 1,000 parts by weight, 45 parts by weight to 1,000 parts by weight, 30 parts by weight to 900 parts by weight, 40 parts by weight to 900 parts by weight, 45 parts by weight to 900 parts by weight, 30 parts by weight to 800 parts by weight, 40 parts by weight to 800 parts by weight, 45 parts by weight to 800 parts by weight, 30 parts by weight to 750 parts by weight, 40 parts by weight to 750 parts by weight, or 45 parts by weight to 750 parts by weight, relative to 100 parts by weight of the oligosaccharide.

The method of increasing acid resistance of the oligosaccharide according to the present application may further include applying a salt to the allulose or the oligosaccharide before, after, or simultaneously with applying the allulose to the oligosaccharide. Specifically, the method of increasing acid resistance of the oligosaccharide according to the present application may further include applying a salt to the allulose after applying the allulose to the oligosaccharide.

In the method of increasing acid resistance of the oligosaccharide according to the present application, the salt may be applied in an amount of 0.05 parts by weight to 0.5 parts by weight, specifically 0.1 parts by weight to 0.5 parts by weight or 0.1 parts by weight to 0.3 parts by weight, relative to 100 parts by weight of the sweetener.

In the method of increasing acid resistance and heat resistance of the oligosaccharide, taste of the oligosaccharide may also be improved.

In accordance with a further aspect of the present application, there is provided a food composition including the sweetener including an oligosaccharide having increased acid resistance according to the present application. The food composition according to the present application may include general foods, health foods, and medicinal (or patient) foods, without being limited thereto. Specifically, the food composition may include drinks (e.g., dietary fiber drinks, carbonated water, baked flour soup, etc.), bakery products, sauces (e.g., pork cutlet sauce, etc.), milk products (such as fermented milk), braised foods (e.g., braised quail eggs, braised mackerel, soy sauce braised potatoes, braised black beans, soy sauce braised saury, etc.), rice with beef, stir-fried foods (e.g., stir-fried fish cake, stir-fried eggplant, stir-fried anchovies, stir-fried squid, stir-fried dried squid, stir-fried vegetables, stir-fried beef, etc.), salads (e.g., seasoned raw vegetables, shredded daikon, yellowish overripe cucumber salad, seasoned vegetables, etc.), grilled foods (grilled squid, roasted ribs, grilled rice cake, etc.), syrups, dressing, stir-fried rice cake, bulgogi, steamed chili, kiwi tea, ssamjang, or processed foods.

When the sweetener according to the present application is used in the food composition, the sweetener may be used alone or in combination with other ingredients, and may be suitably used according to a typical method. In addition, the food composition according to the present application may include various flavoring agents or natural carbohydrates as an additional ingredient. Examples of the natural carbohydrates may include monosaccharides such as glucose and fructose, disaccharides such as maltose and sucrose, polysaccharides such as dextrin and cyclodextrin, and sugar alcohols such as xylitol, sorbitol and erythritol. Examples of the flavoring agents may include natural sweetener such as thaumatin and stevia extract and synthetic sweetener such as saccharin and aspartame.

Further, the food composition according to the present application may further include various nutrients, vitamins, electrolytes, flavors, colorants, pectin and salts thereof, alginic acid and salts thereof, organic acids, protective colloid thickeners, pH adjusters, stabilizers, preservatives, glycerin, alcohols, carbonating agents used in carbonated drinks, and the like. In addition to these, the food composition according to the present application may contain fruit pulp for natural fruit juices, fruit juice drinks and vegetable drinks. These ingredients may be may be used alone or in combination thereof. These additional ingredients may be present in an amount of 0.01 parts by weight to 0.20 parts by weight relative to 100 parts by weight of the food composition according to the present application.

Since the sweetener used in the food composition includes the sweetener including an oligosaccharide having increased acid resistance according to the present application, a detailed description thereof will be omitted.

In accordance with yet another aspect of the present application, there is provided a method for improving taste of a food, which includes adding a sweetener including allulose and an oligosaccharide to the food.

In the method for improving taste according to the present application, the sweetener may be a sweetener including oligosaccharide having increased acid resistance and/or heat resistance.

In the method for improving taste of a food according to the present application, the allulose may be present in the sweetener in an amount of 20 parts by weight to 1,000 parts by weight, 25 parts by weight to 1,000 parts by weight, 45 parts by weight to 1,000 parts by weight, 100 parts by weight to 1,000 parts by weight, 20 parts by weight to 750 parts by weight, 45 parts by weight to 750 parts by weight, 100 parts by weight to 750 parts by weight, 20 parts by weight to 500 parts by weight, 45 parts by weight to 500 parts by weight, 100 parts by weight to 500 parts by weight, 20 parts by weight to 300 parts by weight, 45 parts by weight to 300 parts by weight, 100 parts by weight to 300 parts by weight, 20 parts by weight to 231 parts by weight, 45 parts by weight to 231 parts by weight, or 100 parts by weight to 231 parts by weight, relative to 100 parts by weight of the oligosaccharide.

In the method for improving taste of a food according to the present application, improvement in taste may be improvement in sweetness.

Since the food has been described in the above food composition is the identical to that in the method for improving taste of the food according to aspects of the present application, detailed description thereof will be omitted.

According to the present application, it is possible to provide a sweetener which includes an oligosaccharide improved in acid resistance, heat resistance, and taste, thereby considerably improving taste of a food when added to the food.

As a result, the sweetener can preserve health functionalities (beneficial effects on intestinal health, etc.) of oligosaccharides, improve stability during storage/distribution, improve taste without causing increase in caloric content, and have increased applicability to foods.

In one aspect, the present disclosure relates to an aerated water comprising water, carbonic acid, and allulose.

It is another aspect of the present disclosure to provide a method of preparing an aerated water, a method of improving taste of an aerated water, and a method of maintaining carbon dioxide pressure of an aerated water, which comprise: (i) (a) adding allulose to water and (b) adding carbonic acid to the resulting product of the step (a); or (ii) adding allulose to water containing the carbonic acid.

One aspect of the present disclosure relates to an aerated water comprising water, carbonic acid, and allulose.

As used herein, “aerated water” refers to water in which carbonic acid (i.e., carbon dioxide, H₂CO₃, HCO₃⁻, CO₃²⁻) is dissolved and may include water naturally containing carbonic acid, natural carbonic acid-containing water with carbonic acid further added thereto, and water having carbonic acid added thereto.

As used herein, “water” may include purified water, refined water, ground water, or ion-containing drinking water. However, it should be understood that the present disclosure is not limited thereto and the water may include any suitable water that can be converted into aerated water. The purified water may include purified water obtained by ion-exchange purification of tap water or purified water obtained by filtering ground water, without being limited thereto. The ion-containing drinking water refers to drinking water in which salts are dissolved and ionized.

The aerated water may be free from at least one selected from the group consisting of saccharides other than allulose, synthetic sweeteners, organic acids, edible pigments, caffeine, and preservatives.

The aerated water may have a pH of 4.0 to 6.0.

The aerated water may be colorless and transparent.

The allulose may be present in an amount of 0.1 parts by weight to 5.0 parts by weight relative to 100 parts by weight of the aerated water. Specifically, the allulose may be present in an amount of 0.3 parts by weight to 5.0 parts by weight, 0.5 parts by weight to 5.0 parts by weight, 1.2 parts by weight to 5.0 parts by weight, 3.0 parts by weight to 5.0 parts by weight, 0.3 parts by weight to 4.0 parts by weight, 0.5 parts by weight to 4.0 parts by weight, 1.2 parts by weight to 4.0 parts by weight, 3.0 parts by weight to 4.0 parts by weight, 0.3 parts by weight to 3.0 parts by weight, 0.5 parts by weight to 3.0 parts by weight, or 1.2 parts by weight to 3.0 parts by weight, relative to 100 parts by weight of the aerated water.

The aerated water may have improved properties in terms of carbon dioxide solubility or carbon dioxide pressure retention. Specifically, the aerated water may have a carbon dioxide pressure of 2.5 kg/cm² to 4.5 kg/cm², 3.0 kg/cm² to 4.5 kg/cm², 3.3 kg/cm² to 4.5 kg/cm², 3.5 kg/cm² to 4.5 kg/cm², 3.8 kg/cm² to 4.5 kg/cm², 2.5 kg/cm² to 4.4 kg/cm², 3.0 kg/cm² to 4.4 kg/cm², 3.3 kg/cm² to 4.4 kg/cm², 3.5 kg/cm² to 4.4 kg/cm², or 3.8 kg/cm² to 4.4 kg/cm², as measured at 20° C.

The aerated water may have a carbon dioxide pressure retention rate of 84% or more, specifically 85% or more, 87% or more, or 89% or more as measured after exposure to air at 20° C. for 20 minutes, compared to the carbon dioxide pressure at the time of exposure to air. In another embodiment, the aerated water may have a carbon dioxide pressure retention rate of 89% or more, 90% or more, 91% or more, or 92% or more as measured after exposure to air at 20° C. for 15 minutes, compared to the carbon dioxide pressure at the time of exposure to air. In a further embodiment, the aerated water may have a carbon dioxide pressure retention rate of 93% or more, 94% or more, or 95% or more as measured after exposure to air at 20° C. for 10 minutes, compared to the carbon dioxide pressure at the time of exposure to air. In yet another embodiment, the aerated water may have a carbon dioxide pressure retention rate of 97% or more, 98% or more, or 99% or more as measured after exposure to air at 20° C. for 5 minutes, compared to the carbon dioxide pressure at the time of exposure to air.

The aerated water may have improved taste. Here, improvement in taste may include reduction in acridity, off-taste, and/or off-flavor.

The aerated water may further comprise a flavoring agent. The flavoring agent may be present in an amount of 0.01% by weight (wt %) to 5 wt %, 0.01 wt % to 3 wt %, or 0.01 wt % to 0.3 wt %, based on the total weight of the aerated water. The flavoring agent may be a natural flavoring agent or a synthetic flavoring agent. The natural flavoring agent may be obtained by processing fruits, vegetables, medicinal plants or other plants through any typical method known in the art. The natural flavoring agent may include an ingredient separated from a natural material through steam distillation, squeezing, juicing, or extraction (e.g., water or ethanol extraction). The flavoring agent may be a flavoring agent comprising at least one flavor selected from the group consisting of coffee, black tea, green tea, oolong tea, cocoa, herb, fruits, lime, grape, apple, lemon, strawberry, raspberry, corn, orange, kumquat, tangerine, cinnamon, grapefruit, peach, apricot, pear, apple, pineapple, cranberry, blackberry, magnolia berry, matrimony vine, blueberry, blackcurrant, pomegranate, acai berry, banana, mango, guava, watermelon, dragon fruit, durian, melon, Japanese apricot, kiwi, plum, dried plum, chokeberry, papaya, radish, bell pepper, red bell pepper, watercress, parsley, cauliflower, cabbage, Brussel sprout, cabbage, kale, angelica utilis, spinach, red beet, broccoli, pumpkin, celery, lettuce, tomato, carrot, leek, onion, green onion, pepper, aloe, cactus, elk clover, dandelion, hemp, ginger, corn, Caragana sinica, ladybell, mushrooms, bellflower root, codonopsis lanceolate, Hovenia dulcis, kudzu, red ginseng, and ginseng. The flavoring agent may be present in an amount of 0.01 wt % to 5 wt %, specifically, 0.01 wt % to 3 wt %, more specifically 0.01 wt % to 0.3 wt %, based on the total weight of the aerated water.

The aerated water may further comprise at least one component selected from the group consisting of minerals, salts, electrolytes or amino acids. When the water included in the aerated water according to the present disclosure is natural mineral water, this component may originate from the natural mineral water.

The aerated water may have a calorie content of less than 5 kcal/100 ml, specifically less than 4 kcal/100 ml, less than 3 kcal/100 ml, less than 2 kcal/100 ml, less than 1 kcal/100 ml, or less than 0.5 kcal/100 ml. More specifically, the aerated water may have a calorie content of higher than or equal to 0.1 kcal/100 ml and less than 5 kcal/100 ml, less than 4 kcal/100 ml, less than 3 kcal/100 ml, less than 2 kcal/100 ml, less than 1 kcal/100 ml, or less than 0.5 kcal/100 ml.

In accordance with another aspect of the present disclosure, a method of preparing an aerated water, a method of improving taste of an aerated water, or a method of maintaining carbon dioxide pressure of an aerated water comprises: (i) (a) adding allulose to water and (b) adding carbonic acid to the resulting product of the step (a); or (ii) adding allulose to water containing carbonic acid.

The allulose may be present in an amount of 0.1 parts by weight to 5.0 parts by weight relative to 100 parts by weight of the aerated water. Specifically, the allulose may be present in an amount of 0.3 parts by weight to 5.0 parts by weight, 0.5 parts by weight to 5.0 parts by weight, 1.2 parts by weight to 5.0 parts by weight, 3.0 parts by weight to 5.0 parts by weight, 0.3 parts by weight to 4.0 parts by weight, 0.5 parts by weight to 4.0 parts by weight, 1.2 parts by weight to 4.0 parts by weight, 3.0 parts by weight to 4.0 parts by weight, 0.3 parts by weight to 3.0 parts by weight, 0.5 parts by weight to 3.0 parts by weight, or 1.2 parts by weight to 3.0 parts by weight, relative to 100 parts by weight of the aerated water.

The carbonic acid added to the water or the allulose-containing water may be produced using a carbonic acid generator.

Addition of the carbonic acid may be performed at 0° C. to 10° C., 2° C. to 7° C., or 3° C. to 6° C.

The aerated water prepared by the method according to the present invention may have a carbon dioxide pressure retention rate of 84% or more, specifically 85% or more, 87% or more, or 89% or more as measured after exposure to air at 20° C. for 20 minutes, compared to the carbon dioxide pressure at the time of exposure to air. In another embodiment, the aerated water may have a carbon dioxide pressure retention rate of 89% or more, 90% or more, 91% or more, or 92% or more as measured after exposure to air at 20° C. for 15 minutes, compared to the carbon dioxide pressure at the time of exposure to air. In a further embodiment, the aerated water may have a carbon dioxide pressure retention rate of 93% or more, 94% or more, or 95% or more, as measured after exposure to air at 20° C. for 10 minutes, compared to the carbon dioxide pressure at the time of exposure to air. In yet another embodiment, the aerated water may have a carbon dioxide pressure retention rate of 97% or more, 98% or more, or 99% or more as measured after exposure to air at 20° C. for 5 minutes, compared to the carbon dioxide pressure at the time of exposure to air.

The method may further comprise, after addition of the allulose, mixing or stirring the product resulting from adding the allulose. Here, mixing or stirring may be performed for 10 to 60 minutes, 20 to 60 minutes, 10 to 50 minutes, 20 to 50 minutes, 10 to 40 minutes, or 20 to 40 minutes.

In the method, the water, the carbonic acid, the allulose, and the carbon dioxide pressure are the same as described in the above aspect.

Although some embodiments have been described herein, it should be understood that these embodiments are provided for illustration only and are not to be construed in any way as limiting the present invention, and that various modifications, changes, alterations, and equivalent embodiments can be made by those skilled in the art without departing from the spirit and scope of the invention. The scope of the present invention should be defined by the appended claims and equivalents thereof.

The present disclosure provides an aerated water which includes allulose and thus can have improved taste, particularly reduced acridity, off-flavor, and off-taste, thereby improving consumer preference.

In addition, according to the present disclosure, it is possible to increase solubility of carbonic acid in the aerated water and to prevent reduction in carbon dioxide pressure over time.

In one aspect, the present disclosure provides fermented milk comprising saccharides comprising high content of allulose.

In another aspect, the present disclosure provides a method of improving storability of fermented milk including: adding saccharides comprising high content of allulose in a lactic acid bacteria-culture product.

In another aspect, the present disclosure provides a growth inhibitor for microorganisms comprising saccharides comprising high content of allulose.

In accordance with one aspect of the present disclosure, fermented milk contains saccharides comprising saccharides comprising allulose, wherein the allulose is contained in an amount of 70 parts by weight or more, relative to 100 parts by weight of the saccharides in terms of dried solid content.

The fermented milk may contain allulose in an amount of 80 parts by weight or more, 90 parts by weight or more, 95 parts by weight or more, 98 parts by weight or more, 70 to 100 parts by weight, 80 to 100 parts by weight, 90 to 100 parts by weight, 93 to 100 parts by weight, 95 to 100 parts by weight, 97 to 100 parts by weight, 98 to 100 parts by weight, 70 to 99 parts by weight, 80 to 99 parts by weight, 90 to 99 parts by weight, 93 to 99 parts by weight, 95 to 99 parts by weight, 97 to 99 parts by weight, or 98 to 99 parts by weight, relative to 100 parts by weight of the saccharides in terms of dried solid content.

The allulose in the present disclosure may be extracted directly from natural products, or may be chemically synthesized or biologically prepared, but is not limited thereto. In addition, the allulose may be provided in a crystal form or liquid form (that is, a syrup form). Liquid allulose may contain allulose in an amount of 70 to 99 wt % in terms of dried solid content (ds or DS). Further, crystal allulose may contain allulose in an amount of 90 to 100 wt % in terms of dried solid content.

As used herein, the term “fermented milk” refers to a product obtained by fermenting raw milk with microorganisms and includes fermented milk, thickened fermented milk, cream fermented milk, thickened cream fermented milk, fermented butter milk, and fermented milk powder according to Processing Standards and Ingredient Specifications for Livestock Products (Korea), but is not limited thereto. As used herein, the term “raw milk” may be one or more selected from the group consisting of raw milk, low-fat milk, fat-free milk, reconstituted milk, reconstituted low-fat milk, milk powder, and skim milk powder, but is not limited thereto.

A difference in pH of the fermented milk according to the present disclosure at 7° C. after a date selected in 21 to 31 days from a manufacturing date, may be 0.30 or less. In detail, a difference in pH of the fermented milk according to the present disclosure at 7° C. after a date selected in 21 to 28 days from the manufacturing date, may be 0.28 or less, or after a date selected in 21 to 24 days from manufacturing date, may be 0.27 or less.

Further, a pH of the fermented milk according to the present disclosure at 7° C. after a date selected in 14 to 35 days from the manufacturing date, may be in a range of 4.25 to 4.5.

A difference in titratable acidity of the fermented milk according to the present disclosure may be 0.20% or less, at 7° C. after a date selected in 17 to 28 days from the manufacturing date, as calculated according to the following Equation 1:

$$Titratable acidity ( \% ) = \frac{0.1 N NaOH titration amount ( ml ) \times {0.009}^{*} \times {F}^{**}}{Sample weight ( g )} \times 100 \qquad 〈 Equation 1 〉$$

$${}^{*} 1 ml of 0.1 N NaOH corresponds to 0.009 g of lactic acid .$$

$${}^{**} Factor of 0.1 N NaOH$$

Further, titratable acidity of the fermented milk according to the present disclosure may be less than 1.0%, at 7° C. after a date selected in 14 to 35 days from the manufacturing date, as calculated according to the above Equation 1.

The fermented milk according to the present disclosure may contain at least one kind of microorganisms selected from the group consisting of microorganisms of the genus Lactobacillus, microorganisms of the genus Bifidobacterium, and microorganisms of the genus Streptococcus. In detail, the fermented milk according to the present disclosure may contain at least one kind of microorganisms selected from the group consisting of Lactobacillus acidophilus, Lactobacillus mesenteroides, Lactobacillus gasseri, Lactobacillus delbrueckii, Lactobacillus rhamnosus, Lactobacillus casei, Lactobacillus brevis, Lactobacillus salivarius, Lactobacillus plantarum, Bifidobacterium lactis, and Streptococcus thermophilus.

In addition, according to the present disclosure, allulose may be contained in an amount of 5 to 15 parts by weight, 5 to 10 parts by weight, or 5 to 8 parts by weight in terms of dried solid content, relative to 100 parts by weight of the fermented milk.

The saccharides may additionally include glucose, fructose, or a combination thereof. In detail, the glucose, fructose, or the combination thereof according to the present disclosure may be included in an amount of 35 parts by weight or less, 30 parts by weight or less, 25 parts by weight or less, 20 parts by weight or less, 15 parts by weight or less, 10 parts by weight or less, 5 parts by weight or less, 1 to 35 parts by weight, 1 to 30 parts by weight, 1 to 25 parts by weight, 1 to 20 parts by weight, 1 to 15 parts by weight, 1 to 10 parts by weight, 1 to 5 parts by weight, 5 to 35 parts by weight, 5 to 30 parts by weight, 5 to 25 parts by weight, 5 to 20 parts by weight, 5 to 15 parts by weight, 5 to 10 parts by weight, 10 to 35 parts by weight, 10 to 30 parts by weight, 10 to 25 parts by weight, 10 to 20 parts by weight, 10 to 15 parts by weight, 15 to 35 parts by weight, 15 to 30 parts by weight, 15 to 25 parts by weight, 15 to 20 parts by weight, 20 to 35 parts by weight, 20 to 30 parts by weight, 20 to 25 parts by weight, 25 to 35 parts by weight, 25 to 30 parts by weight, or 30 to 35 parts by weight, relative to 100 parts by weight of the saccharides in terms of dried solid content. The fermented milk according to the present disclosure may additionally contain one or more saccharides (for example, monosaccharides, disaccharides, oligosaccharides, sugar alcohols, high-strength sweetener, and liquid sugar) in addition to allulose, glucose, and fructose.

More specifically, examples of the monosaccharides may include arabinose, xylose, tagatose, allose, galactose, and the like. The disaccharides refer to two monosaccharide units linked together, and examples thereof may include lactose, maltose, trehalose, turanose, cellobiose, and the like. The oligosaccharides refer to 3 or more monosaccharide units linked together, and examples thereof may include fructooligosaccharide, isomaltooligosaccharide, xylooligosaccharide, gentiooligosaccharide, malto-oligosaccharide, and galactooligosaccharide. Further, the sugar alcohols refer to compounds obtained by reducing a carbonyl group in saccharides, and examples thereof may include erythritol, xylitol, arabitol, mannitol, sorbitol, maltitol, and lactitol. The high-intensity sweeteners refer to sweeteners having a sweetness ten times or greater that of sucrose, and examples thereof may include aspartame, acesulfame K, rebaudioside A, and sucralose. The liquid sugar refers to sugar containing a sweetener in a liquid form, and examples thereof may include starch syrup, honey, maple syrup, and agave syrup, but are not limited thereto.

In another embodiment, the saccharides according to the present disclosure may not contain sucrose, glucose, or a combination thereof.

The fermented milk according to the present disclosure may additionally contain 80 to 95 parts by weight of milk, relative to 100 parts by weight of the fermented milk. The milk may be raw milk, milk powder, whole milk powder, skim milk powder, or a combination thereof.

Further, the number of lactic acid bacteria in the fermented milk according to the present disclosure may be 108 cfu/ml or more, at 7° C. after a date selected in 14 to 35 days from the manufacturing date.

In accordance with another aspect of the present disclosure, a method of improving storability of fermented milk includes: adding saccharides comprising allulose to a lactic acid bacteria-culture product, wherein the allulose is contained in an amount of 70 parts by weight or more, relative to 100 parts by weight of the saccharides in terms of dried solid content.

The lactic acid bacteria used in the method of improving storability of fermented milk may be microorganisms contained in the above-mentioned fermented milk.

In detail, improvement of storability may be caused by suppression of a decrease in pH, suppression of an increase in acidity, suppression of an increase in sourness, suppression of post-fermentation, or suppression of growth of microorganism.

In the method of improving storability of fermented milk, the adding of the saccharides comprising allulose may be adding the saccharides and milk to the lactic acid bacteria-culture product.

In accordance with another aspect of the present disclosure, a growth inhibitor for at least one kind of microorganisms selected from the group consisting of Lactobacillus acidophilus, Lactobacillus mesenteroides, Lactobacillus gasseri, Lactobacillus delbrueckii, Lactobacillus rhamnosus, Lactobacillus casei, Lactobacillus brevis, Lactobacillus salivarius, Lactobacillus plantarum, Bifidobacterium lactis, and Streptococcus thermophilus, contains saccharides comprising allulose.

In the growth inhibitor, allulose may be contained in an amount of 70 parts by weight or more, relative to 100 parts by weight of the saccharides in terms of dried solid content.

A description of contents of the method of improving storability of fermented milk and the growth inhibitor for microorganisms comprising saccharides comprising allulose will be omitted in order to avoid excessive complexity of the present specification, since their contents are overlapped with contents of the fermented milk comprising saccharides comprising allulose described above (that is, fermented milk, saccharides, allulose, microorganisms contained in the fermented milk, pH, titratable acidity, and the like).

The fermented milk using allulose according to the present disclosure may suppress a decrease in pH and increases in acidity and sourness during cold-storage distribution after manufacturing the product, and suppress post-fermentation and growth of microorganism. Therefore, the fermented milk according to the present disclosure may significantly extend the expiration date of the fermented milk by increasing a sensory quality maintenance period and maintaining the number of lactic acid bacteria. Further, the fermented milk may decrease calorie of the product, such that the fermented milk is beneficial to improving health.

### EXAMPLES

Hereinafter, the present application will be described in more detail through Examples. However, these Examples are for illustrative purposes only, and the scope of the present application is not limited thereto. This will be apparently understood by those skilled in the art to which this application belongs.

Throughout the specification of the present application, “%” used to denote the concentration of a specific substance refers to solid/solid (weight/weight) %, solid/liquid (weight/volume) %, and liquid/liquid (volume/volume) %, unless otherwise stated.

### Example 1: Preparation of Amino Acid Beverages

Amino acid beverages were prepared according to the following procedure by mixing raw materials in the ratios shown in Tables 1 to 3.

First, saccharides, L-amino acids (C J CheilJedang), the grapefruit concentrate (65 Brix, J C World), Rebaudioside-A (Ra90, Macrocare), citric acid, trisodium citrate, refined salt, the stabilizer (T Texture 001, Cargill Sunkyung) and Cloudy (Bolak) were weighed and placed into a beaker, followed by mixing with purified water to a total amount ratio of 100 weight %. In Comparative examples 1 to 4, sucrose (white sugar, C J CheilJedang) was used as the saccharides, and in Experimental examples 1 to 20, allulose (liquid allulose, 71 Brix, 95% or more of allulose based on dry solids) was used as the saccharides and the contents thereof were 3, 5, 10, 15, and 18 weight % [based on dry solids, 2.02, 3.37, 6.75, 10.12, and 12.14 weight %]. As L-amino acids, Experimental examples 1, 5, 9, 13 and 17 used L-arginine; Experimental examples 2, 6, 10, 14, and 18 used L-methionine; Experimental examples 3, 7, 11, 15, and 19 used L-ornithine; and Experimental examples 4, 8, 12, 16, and 20 used L-citrulline. Thereafter, the mixture was homogenized by mixing on a magnetic stirrer for 20 minutes, and the grapefruit flavor (Samjung Flavor) was put in accordance with a mixing ratio into the obtained homogenized mixture. A glass container was filled with the mixture, sealed with a cap, sterilized at 95° C. in a constant temperature water bath (Hanil Science, HA-35) for 10 minutes, subjected to a primary cooling at room temperature (25° C.) and a secondary cooling at 5° C. to 10° C., so that the amino acid beverage was prepared finally.

TABLE 1

| Classification | Comparative | Comparative | Comparative | Comparative |
|---|---|---|---|---|
| (weight %) | example 1 | example 2 | example 3 | example 4 |
| White sugar | 10 | 10 | 10 | 10 |
| Allulose | — | — | — | — |
| L-Arginine | 0.1 | — | — | — |
| L-Methionine | — | 0.1 | — | — |
| L-Ornithine | — | — | 0.1 | — |
| L-Citrulline | — | — | — | 0.1 |
| Grapefruit concentrate | 0.2 | 0.2 | 0.2 | 0.2 |
| Rebaudioside-A | 0.005 | 0.005 | 0.005 | 0.005 |
| Citric acid | 0.12 | 0.12 | 0.12 | 0.12 |
| Trisodium citrate | 0.05 | 0.05 | 0.05 | 0.05 |
| Refined salt | 0.1 | 0.1 | 0.1 | 0.1 |
| Stabilizer | 0.02 | 0.02 | 0.02 | 0.02 |
| Cloudy | 0.03 | 0.03 | 0.03 | 0.03 |
| Grapefruit flavor | 0.19 | 0.19 | 0.19 | 0.19 |
| Purified water | 89.185 | 89.185 | 89.185 | 89.185 |
| Total | 100 | 100 | 100 | 100 |

| Classification | Experimental | Experimental | Experimental | Experimental |
|---|---|---|---|---|
| (weight %) | example 1 | example 2 | example 3 | example 4 |
| White sugar | — | — | — | — |
| Allulose | 3 | 3 | 3 | 3 |
| L-Arginine | 0.1 | — | — | — |
| L-Methionine | — | 0.1 | — | — |
| L-Ornithine | — | — | 0.1 | — |
| L-Citrulline | — | — | — | 0.1 |
| Grapefruit concentrate | 0.2 | 0.2 | 0.2 | 0.2 |
| Rebaudioside-A | 0.005 | 0.005 | 0.005 | 0.005 |
| Citric acid | 0.12 | 0.12 | 0.12 | 0.12 |
| Trisodium citrate | 0.05 | 0.05 | 0.05 | 0.05 |
| Refined salt | 0.1 | 0.1 | 0.1 | 0.1 |
| Stabilizer | 0.02 | 0.02 | 0.02 | 0.02 |
| Cloudy | 0.03 | 0.03 | 0.03 | 0.03 |
| Grapefruit flavor | 0.19 | 0.19 | 0.19 | 0.19 |
| Purified water | 96.185 | 96.185 | 96.185 | 96.185 |
| Total | 100 | 100 | 100 | 100 |

TABLE 2

| Classification | Experimental | Experimental | Experimental | Experimental |
|---|---|---|---|---|
| (weight %) | example 5 | example 6 | example 7 | example 8 |
| White sugar | — | — | — | — |
| Allulose | 5 | 5 | 5 | 5 |
| L-Arginine | 0.1 | — | — | — |
| L-Methionine | — | 0.1 | — | — |
| L-Ornithine | — | — | 0.1 | — |
| L-Citrulline | — | — | — | 0.1 |
| Grapefruit concentrate | 0.2 | 0.2 | 0.2 | 0.2 |
| Rebaudioside-A | 0.005 | 0.005 | 0.005 | 0.005 |
| Citric acid | 0.12 | 0.12 | 0.12 | 0.12 |
| Trisodium citrate | 0.05 | 0.05 | 0.05 | 0.05 |
| Refined salt | 0.1 | 0.1 | 0.1 | 0.1 |
| Stabilizer | 0.02 | 0.02 | 0.02 | 0.02 |
| Cloudy | 0.03 | 0.03 | 0.03 | 0.03 |
| Grapefruit flavor | 0.19 | 0.19 | 0.19 | 0.19 |
| Purified water | 94.185 | 94.185 | 94.185 | 94.185 |
| Total | 100 | 100 | 100 | 100 |

| Classification | Experimental | Experimental | Experimental | Experimental |
|---|---|---|---|---|
| (weight %) | example 9 | example 10 | example 11 | example 12 |
| White sugar | — | — | — | — |
| Allulose | 10 | 10 | 10 | 10 |
| L-Arginine | 0.1 | — | — | — |
| L-Methionine | — | 0.1 | — | — |
| L-Ornithine | — | — | 0.1 | — |
| L-Citrulline | — | — | — | 0.1 |
| Grapefruit concentrate | 0.2 | 0.2 | 0.2 | 0.2 |
| Rebaudioside-A | 0.005 | 0.005 | 0.005 | 0.005 |
| Citric acid | 0.12 | 0.12 | 0.12 | 0.12 |
| Trisodium citrate | 0.05 | 0.05 | 0.05 | 0.05 |
| Refined salt | 0.1 | 0.1 | 0.1 | 0.1 |
| Stabilizer | 0.02 | 0.02 | 0.02 | 0.02 |
| Cloudy | 0.03 | 0.03 | 0.03 | 0.03 |
| Grapefruit flavor | 0.19 | 0.19 | 0.19 | 0.19 |
| Purified water | 89.185 | 89.185 | 89.185 | 89.185 |
| Total | 100 | 100 | 100 | 100 |

TABLE 3

| Classification | Experimental | Experimental | Experimental | Experimental |
|---|---|---|---|---|
| (weight %) | example 13 | example 14 | example 15 | example 16 |
| White sugar | — | — | — | — |
| Allulose | 15 | 15 | 15 | 15 |
| L-Arginine | 0.1 | — | — | — |
| L-Methionine | — | 0.1 | — | — |
| L-Ornithine | — | — | 0.1 | — |
| L-Citrulline | — | — | — | 0.1 |
| Grapefruit concentrate | 0.2 | 0.2 | 0.2 | 0.2 |
| Rebaudioside-A | 0.005 | 0.005 | 0.005 | 0.005 |
| Citric acid | 0.12 | 0.12 | 0.12 | 0.12 |
| Trisodium citrate | 0.05 | 0.05 | 0.05 | 0.05 |
| Refined salt | 0.1 | 0.1 | 0.1 | 0.1 |
| Stabilizer | 0.02 | 0.02 | 0.02 | 0.02 |
| Cloudy | 0.03 | 0.03 | 0.03 | 0.03 |
| Grapefruit flavor | 0.19 | 0.19 | 0.19 | 0.19 |
| Purified water | 84.185 | 84.185 | 84.185 | 84.185 |
| Total | 100 | 100 | 100 | 100 |

| Classification | Experimental | Experimental | Experimental | Experimental |
|---|---|---|---|---|
| (weight %) | example 17 | example 18 | example 19 | example 20 |
| White sugar | — | — | — | — |
| Allulose | 18 | 18 | 18 | 18 |
| L-Arginine | 0.1 | — | — | — |
| L-Methionine | — | 0.1 | — | — |
| L-Ornithine | — | — | 0.1 | — |
| L-Citrulline | — | — | — | 0.1 |
| Grapefruit concentrate | 0.2 | 0.2 | 0.2 | 0.2 |
| Rebaudioside-A | 0.005 | 0.005 | 0.005 | 0.005 |
| Citric acid | 0.12 | 0.12 | 0.12 | 0.12 |
| Trisodium citrate | 0.05 | 0.05 | 0.05 | 0.05 |
| Refined salt | 0.1 | 0.1 | 0.1 | 0.1 |
| Stabilizer | 0.02 | 0.02 | 0.02 | 0.02 |
| Cloudy | 0.03 | 0.03 | 0.03 | 0.03 |
| Grapefruit flavor | 0.19 | 0.19 | 0.19 | 0.19 |
| Purified water | 81.185 | 81.185 | 81.185 | 81.185 |
| Total | 100 | 100 | 100 | 100 |

### Example 2: Organoleptic Evaluation of Amino Acid Beverages

The beverages of Comparative examples and Experimental examples were prepared in respective tasting cups, and organoleptic evaluation was carried out by using a panel of 30 persons. Each tasting cup was given a random number to exclude the prejudices of the organoleptic panel, and the off-taste, off-odor, acridity, and overall preference were measured. Herein, the off-taste, off-odor, acridity, and overall preference were expressed as the values of 1 to 5, and the higher the organoleptic intensities of the off-taste, off-odor, and the acridity, the larger the expressed values thereof, and the better the overall preference, the larger the expressed value.

As a result, in Experimental examples 5 to 16, it was found that the intensities of off-taste, off-odor, and acridity were reduced, and the overall preference was significantly improved, compared to Comparative example (arginine organoleptic evaluation of Table 4, methionine organoleptic evaluation of Table 5, ornithine organoleptic evaluation of Table 6, and citrulline organoleptic evaluation of Table 7). Therefore, it was found clearly that allulose was added to beverages containing amino acids so as to relieve the off-taste, off-odor and acridity, and enhance the overall preference.

TABLE 4

| | Off-taste, | | Overall | |
|---|---|---|---|---|
| Classification | off-odor | Acridity | preference | Note |
| Comparative | 4.5 | 4.2 | 2.3 | -(Arginine) |
| example 1 | | | | |
| Experimental | 4.2(p > 0.05) | 3.8(p > 0.05) | 2.5(p > 0.05) | P: T-test paired comparison |
| example 1 | | | | values (p < 0.05, significant |
| Experimental | 3.1(p < 0.05) | 3.1(p < 0.05) | 3.2(p < 0.05) | difference occurrence) |
| example 5 | | | | |
| Experimental | 3.2(p < 0.05) | 2.8(p < 0.05) | 3.3(p < 0.05) | |
| example 9 | | | | |
| Experimental | 3.2(p < 0.05) | 2.7(p < 0.05) | 3.8(p < 0.05) | |
| example 13 | | | | |
| Experimental | 3.8(p > 0.05) | 3.8(p > 0.05) | 3.1(p > 0.05) | |
| example 17 | | | | |

* The t-test value is a statistical value between the value of each Experimental example and the value of Camparative example 1.

TABLE 5

| | Off-taste, | | Overall | |
|---|---|---|---|---|
| Classification | off-odor | Acridity | preference | Note |
| Comparative | 4.7 | 4.5 | 1.8 | -(Methionine) |
| example 2 | | | | |
| Experimental | 4.3(p > 0.05) | 4.0(p > 0.05) | 2.6(p > 0.05) | P: T-test paired comparison |
| example 2 | | | | values (p < 0.05, significant |
| Experimental | 3.0(p < 0.05) | 3.2(p < 0.05) | 2.8(p < 0.05) | difference occurrence) |
| example 6 | | | | |
| Experimental | 3.3(p < 0.05) | 3.0(p < 0.05) | 3.1(p < 0.05) | |
| example 10 | | | | |
| Experimental | 3.4(p < 0.05) | 2.8(p < 0.05) | 3.9(p < 0.05) | |
| example 14 | | | | |
| Experimental | 4.2(p > 0.05) | 4.0(p > 0.05) | 2.9(p > 0.05) | |
| example 18 | | | | |

* The t-test value is a statistical value between the value of each Experimental example and the value of Camparative example 2.

TABLE 6

| | Off-taste, | | Overall | |
|---|---|---|---|---|
| Classification | off-odor | Acridity | preference | Note |
| Comparative | 4.5 | 4.3 | 2.5 | -(Ornithine) |
| example 3 | | | | |
| Experimental | 4.1(p > 0.05) | 4.1(p > 0.05) | 2.1(p > 0.05) | P: T-test paired comparison |
| example 3 | | | | values (p < 0.05, significant |
| Experimental | 2.9(p < 0.05) | 3.1(p < 0.05) | 2.9(p < 0.05) | difference occurrence) |
| example 7 | | | | |
| Experimental | 3.2(p < 0.05) | 2.9(p < 0.05) | 3.0(p < 0.05) | |
| example 11 | | | | |
| Experimental | 3.3(p < 0.05) | 2.5(p < 0.05) | 4.0(p < 0.05) | |
| example 15 | | | | |
| Experimental | 4.3(p > 0.05) | 3.9(p > 0.05) | 3.0(p > 0.05) | |
| example 19 | | | | |

* The t-test value is a statistical value between the value of each Experimental example and the value of Camparative example 3.

TABLE 7

| | Off-taste, | | Overall | |
|---|---|---|---|---|
| Classification | off-odor | Acridity | preference | Note |
| Comparative | 4.4 | 4.2 | 2.4 | -(Citrulline) |
| example 4 | | | | |
| Experimental | 4.0(p > 0.05) | 4.2(p > 0.05) | 2.3(p > 0.05) | P: T-test paired comparison |
| example 4 | | | | values (p < 0.05, significant |
| Experimental | 3.1(p < 0.05) | 3.3(p < 0.05) | 3.1(p < 0.05) | difference occurrence) |
| example 8 | | | | |
| Experimental | 3.0(p < 0.05) | 3.1(p < 0.05) | 3.5(p < 0.05) | |
| example 12 | | | | |
| Experimental | 3.3(p < 0.05) | 2.3(p < 0.05) | 4.5(p < 0.05) | |
| example 16 | | | | |
| Experimental | 4.1(p > 0.05) | 3.8(p > 0.05) | 3.0(p > 0.05) | |
| example 20 | | | | |

* The t-test value is a statistical value between the value of each Experimental example and the value of Camparative example 4.

### Example 3: Characterization of Amino Acid Beverages

In order to characterize amino acid beverages, the pHs and acidities of Experimental examples were measured. The pH was measured using a pH meter (Mettler Toledo, Seven compact). The acidity was obtained by titrating the sample (s) of each Experimental example weighted (Mettler Toledo, New Classic ML model) with 0.1N NaOH standard solution (Daejung Chemicals & Metals Co., Ltd.), measuring a NaOH titer (V) at the time point when the pH reached 8.1, and substituting the weight value of the sample (s) and the NaOH titer value (V) into [Equation 1] below to yield the acidity.

Acidity=0.6404*V/s [Equation 1]
(wherein *0.6404 is the amount (g) of citric acid corresponding to 1 mL of 0.1N—NaOH)

As a result, it could be found that the pHs of the amino acid beverages were between 3.5 and 4.3, and the acidities were between about 0.1 and 0.15.

TABLE 8

| | Experimental | Experimental | Experimental | Experimental | Experimental | Experimental | Experimental | Experimental |
|---|---|---|---|---|---|---|---|---|
| Classification | example 5 | example 6 | example 7 | example 8 | example 13 | example 14 | example 15 | example 16 |
| pH | 4.38 | 3.6 | 3.71 | 3.61 | 4.6 | 3.71 | 3.57 | 3.59 |
| Acidity | 0.1237 | 0.1428 | 0.1442 | 0.1455 | 0.1140 | 0.1383 | 0.1407 | 0.1369 |

Unless otherwise stated, “%” used to indicate concentration of a certain substance refers to % by weight/weight for solid/solid, % by weight/volume for solid/liquid, and % by volume/volume for liquid/liquid, throughout the specification.

### Example 4. Preparation of Sweetener and Evaluation of Acid Resistance and Heat Resistance

### 1-1. Preparation of Sweetener

Sweeteners (Experimental Examples 1-1, 1-2, 1-3) were prepared as shown in Table 9. Specifically, crystalline allulose (allulose content in solids: 99 wt %, C J Cheiljedang Co., Ltd.) was dissolved in purified water to a solid content of 75 wt % and then added to an oligosaccharide (Beksul fructooligosaccharide, solid content: 75 wt %, fructooligosaccharide content in solids: 55 wt %, C J Cheiljedang Co., Ltd.), followed by sufficiently stirring the mixture at 300 rpm at room temperature using a blender (MAZELA Z, EYELA), thereby preparing the sweeteners.

In Comparative Example 1, an oligosaccharide (Beksul fructooligosaccharide, solid content: 75 wt %, fructooligosaccharide content in solids: 55 wt %, C J Cheiljedang Co., Ltd.) was used.

TABLE 9

| | Oligosaccharide | | | | |
|---|---|---|---|---|---|
| | | Weight of | Allulose | | Weight of |
| | Amount | oligosaccharide | Amount | Weight of | allulose/Weight of |
| Item | (wt %) | (g) | (wt %) | allulose (g) | oligosaccharide |
| Comparative | 100 | 41.25 | | | |
| Example 1 | | | | | |
| Experimental | 80 | 33 | 20 | 14.85 | 0.45 |
| Example 1-1 | | | | | |
| Experimental | 50 | 20.625 | 50 | 37.125 | 1.8 |
| Example 1-2 | | | | | |
| Experimental | 20 | 8.25 | 80 | 59.4 | 7.2 |
| Example 1-3 | | | | | |

### 1-2. Experimental Method

Acid resistance was evaluated by adding 30 wt % of an aqueous citric acid solution to each of the sweetener samples prepared in Comparative Example 1 and Experimental Examples 1-1, 1-2, 1-3, adjusting the sample to a pH of 2, and storing the sample at room temperature. Here, the pH was measured using a pH meter (SEVEN COMPACT, METTLER TOLEDO International Inc.) and a high-viscosity sensor (InLab® Viscous Pro-ISM, METTLER TOLEDO International Inc.).

Acid resistance and heat resistance (i.e., complex stability against acid and heat) were evaluated by storing each of the samples at pH 2 and 85° C.

Time-dependent oligosaccharide content was measured by high performance liquid chromatography (HPLC). Specifically, 1 g of each of the samples of Comparative Example 1 and Experimental Examples 1-1, 1-2, 1-3 was placed in a 50 ml measuring flask and then dissolved in distilled water to prepare a 50 ml solution (20 g/L). Then, the solution was filtered through a 0.2 μm filter, thereby preparing a test solution. As a standard solution, a fructooligosaccharide set (295-73401, Wako Chemical) was used. Specifically, 1 g of each of standard products, 1-Kestose (GF2), Nystose (GF3), and 1-Fructofuranosylnystose (GF4) was weighed into a 50 ml measuring flask and dissolved in distilled water, followed by serially diluting the solution to a concentration of 0.3125 g/L to 20 g/L and filtration with a 0.2 μm filter, thereby preparing the standard solution. The prepared test solution and standard solution were analyzed under conditions listed in Table 10 using an HPLC system (Alliance, Waters, e2695 Separation Modules, USNWaters column Heater Module/RI detector Water 2414/Empower™ Software).

TABLE 10

| | |
|---|---|
| Moving bed | Acetonitrile(80%):DW (20%) |
| Column | 4.6 mm × 250 mm KROMASIL 100-5NH2 |
| Flow rate | 0.8 ml/min |
| Temperature | 35° C. |
| Dose | 20 μl |
| Detector | Differential refractometer |
| | (RID: Refractive Index Detector) |

The oligosaccharide content of each of the samples of Comparative Example 1 and Experimental Examples 1-1 to 1-3 was calculated according to Equation 1, and the oligosaccharide retention rate was calculated according to Equation 2, thereby evaluating stability of oligosaccharides.

Oligosaccharide content (g/100 g)=(Concentration (g/L) of each oligosaccharide component (GF2,GF3, or GF4) determined from calibration curve×Diluted amount (mL)×100)/Weight of sample (g)×1,000 [Equation 1]

Oligosaccharide retention rate (% by weight,hereinafter,%)=(Oligosaccharide content (g/100 g) of sample during storage×100)/Initial oligosaccharide content (g/100 g) of sample Oligosaccharide content and stability analysis of all Comparative Examples and Experimental Examples were carried out in the same manner as above. [Equation 2]

### 1-3. Experiment Result

Acid Resistance

As shown in Table 11, the oligosaccharide (Comparative Example 1) had an oligosaccharide retention rate of 82.3 wt % and 75.6 wt %, as measured after 24 hours and 48 hours of storage under acidic conditions of pH 2 (at room temperature), respectively.

Conversely, the sweeteners with allulose applied to oligosaccharides (Examples 1-1, 1-2, 1-3) had an oligosaccharide retention rate of 90.3 wt % to 92.8 wt % and 82.9 wt % to 86.2 wt %, as measured after 24 hours and 48 hours of storage, respectively, and thus were less degraded in oligosaccharide by about 10% to 15% than the sweetener without allulose. Thus, it was confirmed that acid resistance of oligosaccharides was increased through addition of allulose.

TABLE 11

| | Oligosaccharide retention rate (wt %) | | | | | |
|---|---|---|---|---|---|---|
| | 0 | 4 | 8 | 12 | 24 | 48 |
| Item | hours | hours | hours | hours | hours | hours |
| Comparative | 100.0 | 93.4 | 94.3 | 88.1 | 82.3 | 75.6 |
| Example 1 | | | | | | |
| Experimental | 100.0 | 98.3 | 98.6 | 90.0 | 92.8 | 82.9 |
| Example 1-1 | | | | | | |
| Experimental | 100.0 | 100.0 | 97.7 | 92.3 | 90.3 | 85.8 |
| Example 1-2 | | | | | | |
| Experimental | 100.0 | 99.3 | 98.9 | 93.7 | 92.5 | 86.2 |
| Example 1-3 | | | | | | |

Acid Resistance and Heat Resistance

As shown in Table 12, it can be seen that the sweetener of Comparative Example 1 had an oligosaccharide retention rate of less than 5%, as measured after 4 hours of storage under conditions of pH 2 and 85° C., and the sweeteners of Experimental Examples 1-1, 1-2, 1-3 had an oligosaccharide retention rate of 51.2 wt % to 66.6 wt %. Thus, it was confirmed that the acid resistance and heat resistance were improved by more than 1,000%.

TABLE 12

| | Oligosaccharide retention rate (wt %) | | |
|---|---|---|---|
| Item | 0 hours | 2 hours | 4 hours |
| Comparative | 100.0 | 18.0 | 4.8 |
| Example 1 | | | |
| Experimental | 100.0 | 62.8 | 51.2 |
| Example 1-1 | | | |
| Experimental | 100.0 | 81.2 | 66.6 |
| Example 1-2 | | | |
| Experimental | 100.0 | 73.9 | 56.3 |
| Example 1-3 | | | |

### Example 5: Evaluation of Acid Resistance and Heat Resistance of Sweetener Including Oligosaccharide Having Improved Acid Resistance when Adding Salt to Sweetener

### 2-1. Preparation of Sweetener with Salt Further Added Thereto

As shown in Table 13, sweeteners with a salt further added thereto were prepared by adding salts to the sweeteners prepared in Example 4. Specifically, after sweeteners with allulose applied to oligosaccharide were prepared in the same manner as in Example 4, salts were added to the sweeteners, followed by sufficiently mixing the mixture at 300 rpm at room temperature using a blender (MAZELA Z, EYELA), thereby preparing the sweeteners.

Oligosaccharides and allulose were the same as those of Example 4, and, as the salts, sodium citrate (Jungbunzlauer), sodium lactate (Musashino Chemical Lab., Ltd.), sodium hydrogen carbonate and trisodium phosphate (Seodo Bio Natural Ingredients), all of which are commercially available powdery products, were used.

TABLE 13

| | | Amount (wt %) | | | | | | |
|---|---|---|---|---|---|---|---|---|
| | | | | | | Sodium | | |
| | | | | Sodium | Sodium | hydrogen | Trisodium | |
| Item | Salt | Oligosaccharide | Allulose | citrate | lactate | carbonate | phosphate | Total |
| Comparative | — | 100.00 | | | | | | 100.0 |
| Example 1 | | | | | | | | |
| Comparative | Sodium | 99.85 | | 0.15 | | | | 100.0 |
| Example 2-1 | citrate | | | | | | | |
| Comparative | Sodium | 99.85 | | | 0.15 | | | 100.0 |
| Example 2-2 | lactate | | | | | | | |
| Comparative | Sodium | 99.85 | | | | 0.15 | | 100.0 |
| Example 2-3 | hydrogen | | | | | | | |
| | carbonate | | | | | | | |
| Comparative | Trisodium | 99.85 | | | | | 0.15 | 100.0 |
| Example 2-4 | phosphate | | | | | | | |
| Experimental | — | 80.00 | 20.00 | | | | | 100.0 |
| Example 1-1 | | | | | | | | |
| Experimental | Sodium | 79.85 | 20.00 | 0.15 | | | | 100.0 |
| Example 2-1-1 | citrate | | | | | | | |
| Experimental | Sodium | 79.85 | 20.00 | | 0.15 | | | 100.0 |
| Example 2-1-2 | lactate | | | | | | | |
| Experimental | Sodium | 79.85 | 20.00 | | | 0.15 | | 100.0 |
| Example 2-1-3 | hydrogen | | | | | | | |
| | carbonate | | | | | | | |
| Experimental | Trisodium | 79.85 | 20.00 | | | | 0.15 | 100.0 |
| Example 2-1-4 | phosphate | | | | | | | |
| Experimental | — | 50.00 | 50.00 | | | | | 100.0 |
| Example 1-2 | | | | | | | | |
| Experimental | Sodium | 49.85 | 50.00 | 0.15 | | | | 100.0 |
| Example 2-2-1 | citrate | | | | | | | |
| Experimental | Sodium | 49.85 | 50.00 | | 0.15 | | | 100.0 |
| Example 2-2-2 | lactate | | | | | | | |
| Experimental | Sodium | 49.85 | 50.00 | | | 0.15 | | 100.0 |
| Example 2-2-3 | hydrogen | | | | | | | |
| | carbonate | | | | | | | |
| Experimental | Trisodium | 49.85 | 50.00 | | | | 0.15 | 100.0 |
| Example 2-2-4 | phosphate | | | | | | | |
| Experimental | — | 20.00 | 80.00 | | | | | 100.0 |
| Example 1-3 | | | | | | | | |
| Experimental | Sodium | 19.85 | 80.00 | 0.15 | | | | 100.0 |
| Example 2-3-1 | citrate | | | | | | | |
| Experimental | Sodium | 19.85 | 80.00 | | 0.15 | | | 100.0 |
| Example 2-3-2 | lactate | | | | | | | |
| Experimental | Sodium | 19.85 | 80.00 | | | 0.15 | | 100.0 |
| Example 2-3-3 | hydrogen | | | | | | | |
| | carbonate | | | | | | | |
| Experimental | Trisodium | 19.85 | 80.00 | | | | 0.15 | 100.0 |
| Example 2-3-4 | phosphate | | | | | | | |

### 2-2. Experimental Method

Evaluation of the acid resistance, heat resistance, and time-dependent content of oligosaccharides and the oligosaccharide retention rate were performed in the same manner as in Example 1.

### 2-3. Experiment Result

Acid Resistance

As shown in Table 14, it can be seen that the sweeteners further containing a salt (Experimental Examples 2-1-1 to 2-1-4, 2-2-1 to 2-2-4, and 2-3-1 to 2-3-4) had an oligosaccharide retention rate of 90 wt % or higher, as measured after 48 hours of storage under acidic conditions of pH 2 (at room temperature) and thus exhibited an oligosaccharide degradation rate of 10 wt % or less.

Conversely, as in Example 1, the oligosaccharide (Comparative Example 1) had an oligosaccharide retention rate of 75.6 wt %, as measured under the same conditions as above, and the sweeteners obtained by adding allulose to the sweetener of Comparative Example 1 (Experimental Examples 1-1, 1-2, 1-3) had an oligosaccharide retention rate of less than 90 wt %.

Thus, it was confirmed that the acid resistance could be improved more when a salt was further added than when only allulose was added to oligosaccharides.

TABLE 14

| | Oligosaccharide retention rate (wt %) | | | | | |
|---|---|---|---|---|---|---|
| | 0 | 4 | 8 | 12 | 24 | 48 |
| Item | hours | hours | hours | hours | hours | hours |
| Comparative | 100.0 | 93.4 | 94.3 | 88.1 | 82.3 | 75.6 |
| Example 1 | | | | | | |
| Comparative | 100.0 | 97.7 | 96.0 | 93.6 | 88.8 | 86.7 |
| Example 2-1 | | | | | | |
| Comparative | 100.0 | 96.6 | 97.0 | 95.1 | 89.0 | 84.6 |
| Example 2-2 | | | | | | |
| Comparative | 100.0 | 95.7 | 93.9 | 90.5 | 88.6 | 83.6 |
| Example 2-3 | | | | | | |
| Comparative | 100.0 | 98.6 | 93.3 | 92.3 | 88.8 | 82.6 |
| Example 2-4 | | | | | | |
| Experimental | 100.0 | 98.3 | 98.6 | 90.0 | 92.8 | 82.9 |
| Example 1-1 | | | | | | |
| Experimental | 100.0 | 99.3 | 95.3 | 95.8 | 95.2 | 93.2 |
| Example 2-1-1 | | | | | | |
| Experimental | 100.0 | 100.0 | 99.5 | 93.4 | 95.5 | 91.1 |
| Example 2-1-2 | | | | | | |
| Experimental | 100.0 | 98.3 | 95.9 | 95.8 | 97.8 | 95.8 |
| Example 2-1-3 | | | | | | |
| Experimental | 100.0 | 100.0 | 98.6 | 99.8 | 99.8 | 95.7 |
| Example 2-1-4 | | | | | | |
| Experimental | 100.0 | 100.0 | 97.7 | 92.3 | 90.3 | 85.8 |
| Example 1-2 | | | | | | |
| Experimental | 100.0 | 96.9 | 100.0 | 95.4 | 93.4 | 92.2 |
| Example 2-2-1 | | | | | | |
| Experimental | 100.0 | 100.0 | 99.9 | 93.8 | 91.2 | 90.1 |
| Example 2-2-2 | | | | | | |
| Experimental | 100.0 | 100.0 | 99.7 | 89.8 | 94.4 | 93.4 |
| Example 2-2-3 | | | | | | |
| Experimental | 100.0 | 98.0 | 99.1 | 96.7 | 97.1 | 93.5 |
| Example 2-2-4 | | | | | | |
| Experimental | 100.0 | 99.3 | 98.9 | 93.7 | 92.5 | 86.2 |
| Example 1-3 | | | | | | |
| Experimental | 100.0 | 98.9 | 95.2 | 95.6 | 99.3 | 95.9 |
| Example 2-3-1 | | | | | | |
| Experimental | 100.0 | 100.0 | 96.9 | 97.4 | 95.1 | 95.0 |
| Example2-3-2 | | | | | | |
| Experimental | 100.0 | 100.0 | 100.0 | 98.7 | 100.0 | 99.5 |
| Example 2-3-3 | | | | | | |
| Experimental | 100.0 | 97.9 | 98.7 | 94.6 | 96.4 | 91.2 |
| Example 2-3-4 | | | | | | |

Acid resistance and heat resistance: As shown in Table 15, it can be seen that the sweeteners of Experimental Examples 1-2 to 1-5, 2-2 to 2-5, and 3-2 to 3-5 had an oligosaccharide retention rate of 75.6% to 95.5%, as measured after 4 hours of storage under conditions of pH 2 and 85° C. based on oligosaccharide weight at O hours of storage under the same conditions. That is, the sweeteners had an oligosaccharide retention rate which is 1,575% to 1,990% that of Comparative Example 1 and is increased by 14% to 86%, as compared with Experimental Examples 1-1, 1-2, and 1-3.

Thus, it was confirmed that acid resistance and heat resistance could be improved more when a salt was further added than when only allulose was added to oligosaccharides.

TABLE 15

| | Oligosaccharide retention rate (wt %) | | |
|---|---|---|---|
| Item | 0 hours | 2 hours | 4 hours |
| Comparative | 100.0 | 18.0 | 4.8 |
| Example 1 | | | |
| Comparative | 100.0 | 78.6 | 65.8 |
| Example 2-1 | | | |
| Comparative | 100.0 | 81.8 | 63.2 |
| Example 2-2 | | | |
| Comparative | 100.0 | 84.5 | 70.2 |
| Example 2-3 | | | |
| Comparative | 100.0 | 77.7 | 57.4 |
| Example 2-4 | | | |
| Experimental | 100.0 | 62.8 | 51.2 |
| Example 1-1 | | | |
| Experimental | 100.0 | 100.0 | 93.0 |
| Example 2-1-1 | | | |
| Experimental | 100.0 | 86.4 | 80.3 |
| Example 2-1-2 | | | |
| Experimental | 100.0 | 96.0 | 95.5 |
| Example 2-1-3 | | | |
| Experimental | 100.0 | 100.0 | 89.5 |
| Example 2-1-4 | | | |
| Experimental | 100.0 | 81.2 | 66.6 |
| Example 1-2 | | | |
| Experimental | 100.0 | 97.3 | 94.8 |
| Example 2-2-1 | | | |
| Experimental | 100.0 | 93.8 | 87.1 |
| Example 2-2-2 | | | |
| Experimental | 100.0 | 95.0 | 92.1 |
| Example 2-2-3 | | | |
| Experimental | 100.0 | 94.6 | 90.0 |
| Example 2-2-4 | | | |
| Experimental | 100.0 | 73.9 | 56.3 |
| Example 1-3 | | | |
| Experimental | 100.0 | 92.8 | 80.4 |
| Example 2-3-1 | | | |
| Experimental | 100.0 | 88.9 | 75.6 |
| Example 2-3-2 | | | |
| Experimental | 100.0 | 96.6 | 90.3 |
| Example 2-3-3 | | | |
| Experimental | 100.0 | 97.2 | 90.6 |
| Example 2-3-4 | | | |

### Example 6: Change in Acid Resistance and Heat Resistance with Varying Amount of Salt

### 3-1. Preparation of Sweetener and Experimental Method

Sweeteners were prepared in the same manner as in Example 5 except that the amounts of salts were changed as listed in Table 16.

TABLE 16

| | | Amount (wt %) | | | | | | |
|---|---|---|---|---|---|---|---|---|
| | | | | | | Sodium | | |
| | | | | Sodium | Sodium | hydrogen | Trisodium | |
| Item | Salt | Oligosaccharide | Allulose | citrate | lactate | carbonate | phosphate | Total |
| Comparative | — | 50.00 | 50.00 | | | | | 100.0 |
| Example 3 | | | | | | | | |
| (Experimental | | | | | | | | |
| Examplel-2) | | | | | | | | |
| Experimental | Sodium | 49.95 | 50.00 | 0.05 | | | | 100.0 |
| Example 3-1-A | citrate | | | | | | | |
| Experimental | Sodium | 49.90 | 50.00 | 0.10 | | | | 100.0 |
| Example 3-1-B | citrate | | | | | | | |
| Experimental | Sodium | 49.70 | 50.00 | 0.30 | | | | 100.0 |
| Example 3-1-C | citrate | | | | | | | |
| Experimental | Sodium | 49.50 | 50.00 | 0.50 | | | | 100.0 |
| Example 3-1-D | citrate | | | | | | | |
| Experimental | Sodium | 49.95 | 50.00 | | 0.05 | | | 100.0 |
| Example 3-2-A | lactate | | | | | | | |
| Experimental | Sodium | 49.90 | 50.00 | | 0.10 | | | 100.0 |
| Example 3-2-B | lactate | | | | | | | |
| Experimental | Sodium | 49.70 | 50.00 | | 0.30 | | | 100.0 |
| Example 3-2-C | lactate | | | | | | | |
| Experimental | Sodium | 49.50 | 50.00 | | 0.50 | | | 100.0 |
| Example 3-2-D | lactate | | | | | | | |
| Experimental | Sodium | 49.95 | 50.00 | | | 0.05 | | 100.0 |
| Example 3-3-A | hydrogen | | | | | | | |
| | carbonate | | | | | | | |
| Experimental | Sodium | 49.90 | 50.00 | | | 0.10 | | 100.0 |
| Example 3-3-B | hydrogen | | | | | | | |
| | carbonate | | | | | | | |
| Experimental | Sodium | 49.70 | 50.00 | | | 0.30 | | 100.0 |
| Example 3-3-C | hydrogen | | | | | | | |
| | carbonate | | | | | | | |
| Experimental | Sodium | 49.50 | 50.00 | | | 0.50 | | 100.0 |
| Example 3-3-D | hydrogen | | | | | | | |
| | carbonate | | | | | | | |
| Experimental | Trisodium | 49.95 | 50.00 | | | | 0.05 | 100.0 |
| Example 3-4-A | phosphate | | | | | | | |
| Experimental | Trisodium | 49.90 | 50.00 | | | | 0.10 | 100.0 |
| Example 3-4-B | phosphate | | | | | | | |
| Experimental | Trisodium | 49.70 | 50.00 | | | | 0.30 | 100.0 |
| Example 3-4-C | phosphate | | | | | | | |
| Experimental | Trisodium | 49.50 | 50.00 | | | | 0.50 | 100.0 |
| Example 3-4-D | phosphate | | | | | | | |

As Comparative Example 3, Experimental Example 2-1, having the highest acid resistance and heat resistance, was selected based on the results of Examples 1 and 2.

### 3-2. Experiment Result

Acid Resistance

As shown in Table 17, it can be seen that the sweeteners of Experimental Example group A (3-1-A, 3-2-A, 3-3-A and 3-4-A) each containing a salt (sodium citrate, sodium lactate, sodium hydrogen carbonate, or trisodium phosphate) in an amount of 0.05 wt % based on the total weight of the sweetener had an average oligosaccharide retention rate of 86.7 wt %, as measured after 48 hours of storage under conditions of pH 2 (at room temperature) and thus were slightly increased in acid resistance, as compared with Comparative Example 3 (Experimental Example 2-1) having an oligosaccharide retention rate of 85.8 wt %. In addition, it can be seen that the sweeteners of Experimental Example groups B, C, and D each containing a salt in an amount of 0.10 wt % or more based on the total weight of the sweetener had an average oligosaccharide retention rate of 92.3 wt %, 92.2 wt %, and 91.1 wt %, respectively, and thus were remarkably increased in acid resistance, as compared with Comparative Example 3 having the highest acid resistance among the sweeteners of Example 1.

TABLE 17

| | Oligosaccharide retention rate (wt %) | | | | | |
|---|---|---|---|---|---|---|
| | 0 | 4 | 8 | 12 | 24 | 48 |
| Item | hours | hours | hours | hours | hours | hours |
| Comparative Example 3 | 100.0 | 100.0 | 97.7 | 92.3 | 90.3 | 85.8 |
| (Experimental | | | | | | |
| Example-2) | | | | | | |
| Experimental | 100.0 | 96.6 | 98.2 | 95.0 | 89.5 | 87.0 |
| Example 3-1-A | | | | | | |
| Experimental | 100.0 | 99.3 | 99.8 | 96.6 | 93.4 | 92.2 |
| Example 3-1-B | | | | | | |
| Experimental | 100.0 | 100.0 | 97.1 | 96.5 | 92.8 | 90.6 |
| Example 3-1-C | | | | | | |
| Experimental | 100.0 | 99.6 | 99.2 | 100.0 | 96.0 | 93.9 |
| Example 3-1-D | | | | | | |
| Experimental | 100.0 | 97.1 | 94.4 | 92.4 | 90.4 | 86.4 |
| Example 3-2-A | | | | | | |
| Experimental | 100.0 | 100.0 | 97.6 | 94.9 | 91.9 | 90.1 |
| Example 3-2-B | | | | | | |
| Experimental | 100.0 | 96.0 | 95.1 | 94.9 | 93.3 | 91.4 |
| Example 3-2-C | | | | | | |
| Experimental | 100.0 | 97.1 | 96.8 | 95.0 | 92.3 | 88.9 |
| Example 3-2-D | | | | | | |
| Experimental | 100.0 | 99.8 | 95.4 | 93.0 | 89.7 | 88.7 |
| Example 3-3-A | | | | | | |
| Experimental | 100.0 | 99.7 | 99.7 | 97.1 | 94.4 | 93.4 |
| Example 3-3-B | | | | | | |
| Experimental | 100.0 | 100.0 | 99.4 | 97.2 | 95.6 | 94.5 |
| Example 3-3-C | | | | | | |
| Experimental | 100.0 | 98.5 | 98.8 | 95.0 | 92.7 | 91.5 |
| Example 3-3-D | | | | | | |
| Experimental | 100.0 | 98.9 | 94.7 | 91.5 | 88.0 | 84.6 |
| Example 3-4-A | | | | | | |
| Experimental | 100.0 | 98.0 | 99.1 | 96.7 | 94.7 | 93.5 |
| Example 3-4-B | | | | | | |
| Experimental | 100.0 | 98.0 | 97.3 | 95.1 | 94.8 | 92.5 |
| Example 3-4-C | | | | | | |
| Experimental | 100.0 | 98.6 | 96.9 | 94.8 | 93.1 | 90.1 |
| Example 3-4-D | | | | | | |

Acid Resistance and Heat Resistance

As shown in Table 18, it can be seen that the sweeteners of Experimental Example A group (3-1-A, 3-2-A, 3-3-A and 3-4-A) each containing a salt in an amount of 0.05 wt % based on the total weight of the sweetener had an average oligosaccharide retention rate of 86.9%, as measured after 4 hours of storage under conditions of pH 2 and 85° C., and thus had degradation of oligosaccharide suppressed by 20% or more, as compared with Comparative Example 3 (Experimental Example 2-1) having an oligosaccharide retention rate of 66.6%, as measured under the same conditions as above. In addition, it can be seen that the sweeteners of Experimental Example groups B, C, and D each containing a salt in an amount of 0.10 wt % or more based on the total weight of the sweetener had an average oligosaccharide retention rate of 91.0%, 93.4%, and 95.4%, respectively, and thus exhibited an oligosaccharide degradation rate of less than 10%.

Thus, it was confirmed that, when a salt was added in an amount of 0.05 wt % or more based on the total weight of the sweetener, acid resistance and heat resistance were significantly increased, and when a salt was added in an amount of 0.10 wt % or more based on the total weight of the sweetener, the oligosaccharide degradation rate was reduced to 2% to 13%, such that the sweetener could be more stable against acid and heat.

TABLE 18

| | Oligosaccharide retention rate (wt %) | | |
|---|---|---|---|
| Item | 0 hours | 2 hours | 4 hours |
| Comparative | 100.0 | 81.2 | 66.6 |
| Example 3 | | | |
| (Experimental | | | |
| Example 1-2) | | | |
| Experimental | 100.0 | 97.8 | 95.8 |
| Example 3-1-A | | | |
| Experimental | 100.0 | 97.3 | 94.8 |
| Example 3-1-B | | | |
| Experimental | 100.0 | 98.4 | 98.0 |
| Example 3-1-C | | | |
| Experimental | 100.0 | 97.4 | 96.4 |
| Example 3-1-D | | | |
| Experimental | 100.0 | 90.6 | 84.6 |
| Example 3-2-A | | | |
| Experimental | 100.0 | 93.8 | 87.1 |
| Example 3-2-B | | | |
| Experimental | 100.0 | 95.7 | 93.4 |
| Example 3-2-C | | | |
| Experimental | 100.0 | 96.1 | 93.9 |
| Example 3-2-D | | | |
| Experimental | 100.0 | 91.2 | 85.1 |
| Example 3-3-A | | | |
| Experimental | 100.0 | 95.0 | 92.1 |
| Example 3-3-B | | | |
| Experimental | 100.0 | 97.6 | 93.0 |
| Example 3-3-C | | | |
| Experimental | 100.0 | 95.8 | 96.0 |
| Example 3-3-D | | | |
| Experimental | 100.0 | 89.7 | 82.0 |
| Example 3-4-A | | | |
| Experimental | 100.0 | 94.6 | 90.0 |
| Example 3-4-B | | | |
| Experimental | 100.0 | 94.5 | 89.1 |
| Example 3-4-C | | | |
| Experimental | 100.0 | 97.0 | 95.4 |
| Example 3-4-D | | | |

### Example 7: Evaluation of Palatability of Sweetener Having Increased Acid Resistance

A sensory evaluation was performed to check whether a sweetener increased in acid resistance through application of allulose to oligosaccharide can be improved in sensory quality(palatability or preference).

As shown in Table 19, a sensory test was conducted on Experimental Examples 1-1 to 1-3 and Examples 4-1 to 4-3 obtained by replacing oligosaccharides with isomaltooligosaccharide (Beksul isomaltooligosaccharide, solid content: 75 wt %, isomaltooligosaccharide content in solids: 55 wt %). As Comparative Examples, fructooligosaccharide (Comparative Example 1), isomaltooligosaccharide (Comparative Example 4-1), and allulose (Comparative Example 4-2) were used. Here, the fructooligosaccharide and the allulose were the same as those of Example 1.

TABLE 19

| | Fmctooligosaccharide | | Isomaltooligosaccharide | | Allulose | | Weight of |
|---|---|---|---|---|---|---|---|
| | | Content of | | Content of | | Content of | allulose/Weight |
| | Amount | oligosaccharide | Amount | oligosaccharide | Amount | allulose | of |
| | (wt %) | (g) | (wt %) | (g) | (wt %) | (g) | oligosaccharide |
| Comparative | 100 | 41.25 | | | | | |
| Example 1 | | | | | | | |
| Comparative | | | 100 | 41.25 | | | |
| Example 4-1 | | | | | | | |
| Comparative | | | | | 100 | 74.25 | |
| Example 4-2 | | | | | | | |
| Experimental | 80 | 33 | | | 20 | 14.85 | 0.45 |
| Example 1-1 | | | | | | | |
| Experimental | 50 | 20.63 | | | 50 | 37.125 | 1.8 |
| Example 1-2 | | | | | | | |
| Experimental | 20 | 8.25 | | | 80 | 59.4 | 7.2 |
| Example 1-3 | | | | | | | |
| Experimental | | | 80 | 33 | 20 | 14.85 | 0.45 |
| Example 4-1 | | | | | | | |
| Experimental | | | 50 | 20.63 | 50 | 37.125 | 1.8 |
| Example 4-2 | | | | | | | |
| Experimental | | | 20 | 8.25 | 80 | 59.4 | 7.2 |
| Example 4-3 | | | | | | | |

Each of the sweeteners was diluted to a concentration of 12 Brix % with purified water and adjusted to a temperature of 20° C., thereby preparing a sample. The prepared samples were subjected to sensory evaluation for each item by 15 trained male and female panelists in the 20 to 50 age group. Specifically, the prepared samples (Comparative Examples 4-1 to 4-2, Experimental Examples 1-1 to 1-3, Experimental Examples 4-1 to 4-3) were numbered using a random number table, randomly selected one by one, and given to each panelist. In order to prevent interference between samples, a set of samples including fructooligosaccharide (Comparative Example 1), allulose (Comparative Example 4-2), and sweeteners with allulose applied to fructooligosaccharide (Experimental Examples 1-1 to 1-3) was first subjected to sensory evaluation, and another set of samples including isomaltooligosaccharide (Comparative Example 4-1), allulose (Comparative Example 4-2), and sweetener with allulose applied to isomaltooligosaccharide (Experimental Examples 4-1 to 4-3) was subjected to sensory evaluation.

Here, the sensory evaluation was performed by a procedure in which each panelist expressed the sweetness preference and overall preference of the samples after ingestion on a 9 point scale. The quantified scores for each evaluation item were converted into a 5-point scale (intensity; 1 point-very weak to 5 points-very strong, preference; 1 point-very poor to 5 points-very good). Results are shown in Table 20.

Experimental Examples 1-1 to 1-3 and Experimental Examples 4-1 to 4-3 were compared with Comparative Example 1 and Comparative Example 4-1, respectively, thereby analyzing a statistically significant difference (p<0.05) of the scores for each item. Statistical analysis was also performed in accordance with the T-test with the corresponding Comparative Example for each Experimental example.

TABLE 20

| | Comparative | Comparative | Experimental | Experimental | Experimental |
|---|---|---|---|---|---|
| | Example 1 | Example 4-2 | Example 1-1 | Example 1-2 | Example 1-3 |
| Overall preference | 2.7 ± 0.7 | 3.3 ± 0.7 | 3.4 ± 0.8* | 4.1 ± 0.6* | 4.1 ± 0.7* |
| Sweetness preference | 2.7 ± 0.8 | 3.4 ± 0.8 | 3.4 ± 0.8* | 4.1 ± 0.8* | 4.2 ± 0.6* |
| | Comparative | Comparative | | | |
| | Example 4-1 | Example 4-2 | Example 4-1 | Example 4-2 | Example 4-3 |
| Overall preference | 2.0 ± 0.6 | 3.4 ± 0.9 | 2.8 ± 0.8* | 3.5 ± 0.7* | 3.9 ± 0.8* |
| Sweetness preference | 2.1 ± 0.7 | 3.5 ± 0.9 | 2.8 ± 0.5* | 3.4 ± 0.6* | 3.9 ± 0.6* |

In Table 20, * indicates statistical significance.

As a result of sensory evaluation, it was confirmed that the sweeteners obtained by adding allulose to oligosaccharides were increased in sweetness preference and remarkably improved in overall preference.

### Example 9: Application of Sweetener to Food and Evaluation of Palatability

### 5-1. Bakery Food

Cake sheets (sponge cakes) were prepared according to the formulations as listed in Table 21, followed by performing sensory evaluation. Results are shown in Table 22. In Example 5, the content of each ingredient is based on weight. That is, the content of each ingredient is the number of grams per 100 g (wt %).

Each of the prepared cake sheets was allowed to stand at room temperature for 1 day, numbered using a random number table, and then subjected to sensory evaluation for each item by 15 trained male and female panelists in the 20 to 50 age group. In order to prevent interference between samples, a set of samples was first prepared using fructooligosaccharide (Comparative Example 5-1), allulose (Comparative Example 5-3), and sweeteners obtained by applying allulose to fructooligosaccharide (Experimental Examples 5-1, 5-2, 5-3, 5-4). Composition of each of the cake sheets is shown in Table 13. Then, another set of samples was prepared using isomaltooligosaccharide (Comparative Example 5-2), allulose (Comparative Example 5-3), and sweeteners obtained by applying allulose to isomaltooligosaccharide (Experimental Example 5-5, 5-6, 5-7, 5-8), followed by sensory evaluation for each sample set.

Here, sensory evaluation was performed by a procedure in which each panelist expressed the intensity of sweetness and preference of the samples (cake sheets) after ingestion on a 5 point scale.

TABLE 21

| Ingredient | Comparative | Comparative | Comparative | Experimental | Experimental | Experimental |
|---|---|---|---|---|---|---|
| (wt %) | Example 5-1 | Example 5-2 | Example 5-3 | Example 5-1 | Example 5-2 | Example 5-3 |
| Purified water | 0.6 | 0.6 | 0.6 | 0.6 | 0.6 | 0.6 |
| White sugar | 14.3 | 14.3 | 14.3 | 14.3 | 14.3 | 14.3 |
| Fmctooligosaccharide | 17.9 | | | 16.1 | 12.5 | 8.9 |
| Isomaltooligosaccharide | | 17.9 | | | | |
| Allulose | | | 17.9 | 1.8 | 5.4 | 8.9 |
| Weight of | — | — | — | 0.111 | 0.432 | 1 |
| allulose/Weight of | | | | | | |
| oligosaccharide | | | | | | |
| Egg | 40.9 | 40.9 | 40.9 | 40.9 | 40.9 | 40.9 |
| Weak flour | 24.5 | 24.5 | 24.5 | 24.5 | 24.5 | 24.5 |
| Baking powder | 0.3 | 0.3 | 0.3 | 0.3 | 0.3 | 0.3 |
| Emulsifier | 1.2 | 1.2 | 1.2 | 1.2 | 1.2 | 1.2 |
| Purified salt | 0.3 | 0.3 | 0.3 | 0.3 | 0.3 | 0.3 |

| Ingredient | Experimental | Experimental | Experimental | Experimental | Experimental |
|---|---|---|---|---|---|
| (wt %) | Example 5-4 | Example 5-5 | Example 5-6 | Example 5-7 | Example 5-8 |
| Purified water | 0.6 | 0.6 | 0.6 | 0.6 | 0.6 |
| White sugar | 14.3 | 14.3 | 14.3 | 14.3 | 14.3 |
| Fmctooligosaccharide | 5.4 | | | | |
| Isomaltooligosaccharide | | 16.1 | 12.5 | 8.9 | 5.4 |
| Allulose | 12.5 | 1.8 | 5.4 | 8.9 | 12.5 |
| Weight of | 2.31 | 0.111 | 0.432 | 1 | 2.31 |
| allulose/Weight of | | | | | |
| oligosaccharide | | | | | |
| Egg | 40.9 | 40.9 | 40.9 | 40.9 | 40.9 |
| Weak flour | 24.5 | 24.5 | 24.5 | 24.5 | 24.5 |
| Baking powder | 0.3 | 0.3 | 0.3 | 0.3 | 0.3 |
| Emulsifier | 1.2 | 1.2 | 1.2 | 1.2 | 1.2 |
| Purified salt | 0.3 | 0.3 | 0.3 | 0.3 | 0.3 |

TABLE 22

| | Comparative | Comparative | Experimental | Experimental | Experimental | Experimental |
|---|---|---|---|---|---|---|
| | Example 5-1 | Example 5-2 | Example 5-1 | Example 5-2 | Example 5-3 | Example 5-4 |
| Overall preference | 2.5 ± 0.8 | 2.3 ± 0.8 | 2.5 ± 0.6 | 3.3 ± 0.8* | 3.6 ± 0.8* | 4.1 ± 0.7* |
| Sweetness preference | 2.4 ± 0.6 | 3.4 ± 0.7 | 2.4 ± 0.7 | 2.9 ± 0.8* | 3.5 ± 0.6* | 4.0 ± 0.7* |
| Intensity of sweetness | 2.5 ± 0.8 | 3.8 ± 0.8 | 2.6 ± 0.8 | 3.0 ± 0.7 | 3.4 ± 0.7* | 3.8 ± 0.7* |
| Aftertaste preference | 2.6 ± 0.5 | 2.0 ± 0.5 | 2.5 ± 0.7 | 3.3 ± 0.7* | 3.6 ± 0.6* | 4.1 ± 0.7* |
| Mouthfeel preference | 2.8 ± 0.7 | 2.3 ± 0.7 | 2.6 ± 0.5 | 3.3 ± 0.9 | 3.6 ± 0.6* | 3.5 ± 0.8* |
| | Comparative | Comparative | Experimental | Experimental | Experimental | Experimental |
| | Example 5-1 | Example 5-3 | Example 5-5 | Example 5-6 | Example 5-7 | Example 5-8 |
| Overall preference | 2.3 ± 0.8 | 2.4 ± 0.6 | 2.3 ± 0.8 | 2.3 ± 0.9 | 2.7 ± 0.9 | 3.4 ± 0.9* |
| Sweetness preference | 2.0 ± 0.7 | 3.2 ± 0.9 | 2.1 ± 0.9 | 2.3 ± 0.7 | 2.7 ± 0.6* | 2.9 ± 0.7* |
| Intensity of sweetness | 2.3 ± 0.7 | 3.9 ± 0.8 | 2.4 ± 0.6 | 2.5 ± 0.6 | 2.7 ± 0.5* | 3.1 ± 0.6* |
| Aftertaste preference | 2.3 ± 0.8 | 1.7 ± 0.7 | 2.2 ± 1.0 | 2.3 ± 0.5 | 2.6 ± 0.7 | 3.4 ± 0.6* |
| Mouthfeel preference | 2.5 ± 0.7 | 2.0 ± 0.8 | 2.7 ± 0.8 | 2.8 ± 0.8 | 2.9 ± 0.6 | 3.3 ± 0.5* |

As a result of sensory evaluation, it was confirmed that the cake sheets prepared using the sweeteners obtained by applying allulose to oligosaccharides were increased in intensity of sweetness, sweetness preference, and overall preference as well as in aftertaste preference and mouthfeel preference, as compared with the cake sheets prepared using either oligosaccharide or allulose.

### 5-2. Beverage

Dietary fiber drinks were prepared according to the formulations as listed in Table 23, followed by performing sensory evaluation. Results are shown in Table 24.

Each of the prepared dietary fiber drinks was refrigerated for 1 day, numbered using a random number table, and then subjected to sensory evaluation for each item by 15 trained male and female panelists in the 20 to 50 age group. Interference between samples was prevented in the same manner as in Example 5-1.

TABLE 23

| Ingredient | Comparative | Comparative | Comparative | Experimental | Experimental |
|---|---|---|---|---|---|
| (wt %) | Example 5-4 | Example 5-5 | Example 5-6 | Example 5-9 | Example 5-10 |
| Purified water | 85.82 | 85.82 | 85.82 | 85.82 | 85.82 |
| Fmctooligosaccharide | 9.65 | | | 7.72 | 4.83 |
| Isomaltooligosaccharide | | 9.65 | | | |
| Allulose | | | 9.65 | 1.93 | 4.83 |
| Weight of | — | — | — | 0.25 | 1 |
| allulose/Weight of | | | | | |
| oligosaccharide | | | | | |
| Water soluble | 4.00 | 4.00 | 4.00 | 4.00 | 4.00 |
| dietary fiber | | | | | |
| Enzymatically | 0.02 | 0.02 | 0.02 | 0.02 | 0.02 |
| modified stevia | | | | | |
| glucosyl stevia | | | | | |
| Citric acid | 0.25 | 0.25 | 0.25 | 0.25 | 0.25 |
| Sodium citrate | 0.06 | 0.06 | 0.06 | 0.06 | 0.06 |
| Vitamin C | 0.08 | 0.08 | 0.08 | 0.08 | 0.08 |
| DL-Alanine | 0.02 | 0.02 | 0.02 | 0.02 | 0.02 |
| Flavor | 0.10 | 0.10 | 0.10 | 0.10 | 0.10 |

| Ingredient | Experimental | Experimental | Experimental | Experimental |
|---|---|---|---|---|
| (wt %) | Example 5-11 | Example 5-12 | Example 5-13 | Example 5-14 |
| Purified water | 85.82 | 85.82 | 85.82 | 85.82 |
| Fmctooligosaccharide | 2.90 | | | |
| Isomaltooligosaccharide | | 7.72 | 4.83 | 2.90 |
| Allulose | 6.76 | 1.93 | 4.83 | 6.76 |
| Weight of | 2.33 | 0.24 | 1 | 2.33 |
| allulose/Weight of | | | | |
| oligosaccharide | | | | |
| Water soluble | 4.00 | 4.00 | 4.00 | 4.00 |
| dietary fiber | | | | |
| Enzymatically | 0.02 | 0.02 | 0.02 | 0.02 |
| modified stevia | | | | |
| glucosyl stevia | | | | |
| Citric acid | 0.25 | 0.25 | 0.25 | 0.25 |
| Sodium citrate | 0.06 | 0.06 | 0.06 | 0.06 |
| Vitamin C | 0.08 | 0.08 | 0.08 | 0.08 |
| DL-Alanine | 0.02 | 0.02 | 0.02 | 0.02 |
| Flavor | 0.10 | 0.10 | 0.10 | 0.10 |

TABLE 24

| | Comparative | Comparative | Experimental | Experimental | Experimental |
|---|---|---|---|---|---|
| | Example 5-4 | Example 5-5 | Example 5-9 | Example 5-10 | Example 5-11 |
| Overall preference | 3.0 ± 0.5 | 3.3 ± 0.6 | 3.7 ± 0.5* | 4.1 ± 0.5* | 3.9 ± 0.5* |
| Sweetness preference | 2.9 ± 0.5 | 3.4 ± 0.8 | 3.3 ± 0.4 | 3.6 ± 0.3* | 3.9 ± 0.4* |
| Intensity of sweetness | 2.8 ± 0.4 | 3.8 ± 0.5 | 3.1 ± 0.5 | 3.6 ± 0.5* | 3.9 ± 0.7* |
| Aftertaste preference | 2.8 ± 0.7 | 2.6 ± 0.5 | 2.9 ± 0.4 | 3.2 ± 0.5 | 3.5 ± 0.3* |

| | Comparative | Comparative | Experimental | Experimental | Experimental |
|---|---|---|---|---|---|
| | Example 5-4 | Example 5-6 | Example 5-12 | Example 5-13 | Example 5-14 |
| Overall preference | 2.5 ± 0.6 | 3.5 ± 0.5 | 3.1 ± 0.5* | 3.9 ± 0.6* | 3.8 ± 0.5* |
| Sweetness preference | 2.2 ± 0.6 | 3.4 ± 0.7 | 2.8 ± 0.4* | 3.5 ± 0.4* | 3.7 ± 0.4* |
| Sweetness | 2.1 ± 0.5 | 3.7 ± 0.4 | 2.8 ± 0.5* | 3.4 ± 0.2* | 3.6 ± 0.4* |
| Aftertaste preference | 2.4 ± 0.6 | 2.6 ± 0.5 | 2.7 ± 0.4 | 3.3 ± 0.3* | 3.1 ± 0.2* |

In Table 24, * indicates statistical significance.

As a result of the sensory evaluation, it was confirmed that the dietary fiber drinks prepared using the sweeteners obtained by applying allulose to oligosaccharide were increased in intensity of sweet taste, sweetness preference, and overall preference as well as in aftertaste preference, as compared with the dietary fiber drinks prepared using either oligosaccharide or allulose.

### 5-3. Sauce

Pork cutlet sauces were prepared according to the formulations as listed in Table 25, followed by performing sensory evaluation. Results are shown in Table 26.

Each of the prepared pork cutlet sauces was allowed to stand at room temperature for 1 day, numbered using a random number table, and then subjected to sensory evaluation for each item by 15 trained male and female panelists in the 20 to 50 age group. Here, commercially available frozen pork was cooked and served with the prepared pork cutlet sauces. Interference between samples was prevented in the same manner as in Example 5-1.

TABLE 25

| Ingredient | Comparative | Comparative | Comparative | Experimental | Experimental |
|---|---|---|---|---|---|
| (wt %) | Example 5-7 | Example 5-8 | Example 5-9 | Example 5-15 | Example 5-16 |
| Purified water | 41.94 | 41.94 | 41.94 | 41.94 | 41.94 |
| Fmctooligosaccharide | 25.50 | | | 20.40 | 12.75 |
| Isomaltooligosaccharide | | 25.50 | | | |
| Allulose | | | 25.50 | 5.10 | 12.75 |
| Weight of | — | — | — | 0.25 | 1 |
| allulose/Weight of | | | | | |
| oligosaccharide | | | | | |
| Tomato paste | 12.00 | 12.00 | 12.00 | 12.00 | 12.00 |
| White vinegar | 7.00 | 7.00 | 7.00 | 7.00 | 7.00 |
| Usta sauce | 6.20 | 6.20 | 6.20 | 6.20 | 6.20 |
| Purified salt | 2.30 | 2.30 | 2.30 | 2.30 | 2.30 |
| Anhydrous | 2.00 | 2.00 | 2.00 | 2.00 | 2.00 |
| crystalline glucose | | | | | |
| Modified food starch | 2.00 | 2.00 | 2.00 | 2.00 | 2.00 |
| Caramel | 0.42 | 0.42 | 0.42 | 0.42 | 0.42 |
| Anhydrous citric acid | 0.41 | 0.41 | 0.41 | 0.41 | 0.41 |
| Spice powder | 0.18 | 0.18 | 0.18 | 0.18 | 0.18 |
| Xanthangum | 0.05 | 0.05 | 0.05 | 0.05 | 0.05 |

| Ingredient | Experimental | Experimental | Experimental | Experimental |
|---|---|---|---|---|
| (wt %) | Example 5-17 | Example 5-18 | Example 5-19 | Example 5-20 |
| Purified water | 41.94 | 41.94 | 41.94 | 41.94 |
| Fmctooligosaccharide | 7.65 | | | |
| Isomaltooligosaccharide | | 20.40 | 12.75 | 7.65 |
| Allulose | 17.85 | 5.10 | 12.75 | 17.85 |
| Weight of | 2.33 | 0.25 | 1 | 2.33 |
| allulose/Weight of | | | | |
| oligosaccharide | | | | |
| Tomato paste | 12.00 | 12.00 | 12.00 | 12.00 |
| White vinegar | 7.00 | 7.00 | 7.00 | 7.00 |
| Usta sauce | 6.20 | 6.20 | 6.20 | 6.20 |
| Purified salt | 2.30 | 2.30 | 2.30 | 2.30 |
| Anhydrous | 2.00 | 2.00 | 2.00 | 2.00 |
| crystalline glucose | | | | |
| Modified food starch | 2.00 | 2.00 | 2.00 | 2.00 |
| Caramel | 0.42 | 0.42 | 0.42 | 0.42 |
| Anhydrous citric acid | 0.41 | 0.41 | 0.41 | 0.41 |
| Spice powder | 0.18 | 0.18 | 0.18 | 0.18 |
| Xanthangum | 0.05 | 0.05 | 0.05 | 0.05 |

TABLE 26

| | Comparative | Comparative | Experimental | Experimental | Experimental |
|---|---|---|---|---|---|
| | Example 5-7 | Example 5-9 | Example 5-15 | Example 5-16 | Example 5-17 |
| Overall preference | 2.5 ± 0.5 | 2.8 ± 0.5 | 3.1 ± 0.7* | 3.6 ± 0.5* | 4.1 ± 0.5* |
| Sweetness preference | 2.5 ± 0.3 | 3.7 ± 0.4 | 3.0 ± 0.2* | 3.7 ± 0.4* | 4.1 ± 0.4* |
| Intensity of sweetness | 2.9 ± 0.7 | 4.1 ± 0.6 | 3.1 ± 0.9 | 3.9 ± 0.3* | 4.2 ± 0.5* |
| Sweetness persistency | 2.8 ± 0.3 | 2.1 ± 0.3 | 3.1 ± 0.4 | 3.5 ± 0.4* | 3.7 ± 0.4* |
| | Comparative | Comparative | Experimental | Experimental | Experimental |
| | Example 5-8 | Example 5-9 | Example 5-18 | Example 5-19 | Example 5-20 |
| Overall preference | 2.2 ± 0.5 | 2.7 ± 0.6 | 2.5 ± 0.4 | 3.3 ± 0.4* | 3.7 ± 0.5* |
| Sweetness preference | 1.9 ± 0.5 | 3.5 ± 0.5 | 2.8 ± 0.4* | 3.3 ± 0.6* | 3.8 ± 0.6* |
| Intensity of sweetness | 1.9 ± 0.6 | 3.9 ± 0.4 | 2.6 ± 0.5* | 3.2 ± 0.5* | 3.7 ± 0.6* |
| Sweetness persistency | 2.3 ± 0.5 | 2.2 ± 0.4 | 2.7 ± 0.3 | 2.9 ± 0.4* | 3.1 ± 0.5* |

In Table 26, * indicates statistical significance.

As a result of the sensory evaluation, it was confirmed that the pork cutlet sauces prepared using the sweeteners obtained by applying allulose to oligosaccharide was increased in intensity of sweet taste, sweetness preference, taste persistency, and overall preference, as compared with the pork cutlet sauces prepared using either oligosaccharide or allulose. For meats (pork cutlets), harmony with a sauce is just as important as taste. It is considered that the sweeteners obtained by adding allulose to oligosaccharides had a high score on the overall preference because the sweeteners could maintain the initial sweetness of the food.

### 5-4. Fermented Milk

Using some of Experimental Examples obtained by the afore-described formulations and corresponding Comparative Examples, fermented milk samples were prepared according to the formulations as listed in Table 27, followed by performing sensory evaluation. Results are shown in Table 28.

Each of the prepared fermented milk samples was refrigerated for 1 day, numbered using a random number table, and then subjected to sensory evaluation for each item by 15 trained male and female panelists in the 20 to 50 age group.

In order to prevent interference between samples, a set of fermented milk samples was first prepared using fructooligosaccharide (Comparative Example 5-10), allulose (Comparative Example 5-12), and compositions prepared therefrom (Experimental Examples 5-21, 5-22, 5-23). Composition of each of the fermented milk samples is shown in Table 13. Then, another set of fermented milk samples was prepared using isomaltooligosaccharide (Comparative Example 5-11), allulose (Comparative Example 5-12), and compositions prepared therefrom (Experimental Examples 5-24, 5-25, 5-26), followed by sensory evaluation of each set. Here, the sensory evaluation was performed by a procedure in which each panelist expressed the intensity of sweetness and preference of the samples (fermented milk) after the ingestion on a 5 point scale.

TABLE 27

| Ingredient | Comparative | Comparative | Comparative | Experimental | Experimental |
|---|---|---|---|---|---|
| (wt %) | Example 5-10 | Example 5-11 | Example 5-12 | Example 5-21 | Example 5-22 |
| Purified water | 4.95 | 4.95 | 4.95 | 4.95 | 4.95 |
| High fructose | 3.00 | 3.00 | 3.00 | 3.00 | 3.00 |
| Fructooligosaccharide | 6.00 | | | 4.80 | 3.00 |
| Isomaltooligosaccharide | | 6.00 | | | |
| Allulose | | | 6.00 | 1.20 | 3.00 |
| Weight of | — | — | — | 0.25 | 1 |
| allulose/Weight of | | | | | |
| oligosaccharide | | | | | |
| Raw milk | 77.50 | 77.50 | 77.50 | 77.50 | 77.50 |
| Skimmed milk powder | 2.40 | 2.40 | 2.40 | 2.40 | 2.40 |
| Water soluble | 1.00 | 1.00 | 1.00 | 1.00 | 1.00 |
| dietary fiber | | | | | |
| Pectin | 0.08 | 0.08 | 0.08 | 0.08 | 0.08 |
| Concentrated | 5.00 | 5.00 | 5.00 | 5.00 | 5.00 |
| fruit juice | | | | | |
| Lactobacillus | 0.02 | 0.02 | 0.02 | 0.02 | 0.02 |
| Congener | 0.05 | 0.05 | 0.05 | 0.05 | 0.05 |

| Ingredient | Experimental | Experimental | Experimental | Experimental |
|---|---|---|---|---|
| (wt %) | Example 5-23 | Example 5-24 | Example 5-25 | Example 5-26 |
| Purified water | 4.95 | 4.95 | 4.95 | 4.95 |
| High fructose | 3.00 | 3.00 | 3.00 | 3.00 |
| Fructooligosaccharide | 1.80 | | | |
| Isomaltooligosaccharide | | 4.80 | 3.00 | 1.80 |
| Allulose | 4.20 | 1.20 | 3.00 | 4.20 |
| Weight of | 2.33 | 0.25 | 1 | 2.33 |
| allulose/Weight of | | | | |
| oligosaccharide | | | | |
| Raw milk | 77.50 | 77.50 | 77.50 | 77.50 |
| Skimmed milk powder | 2.40 | 2.40 | 2.40 | 2.40 |
| Water soluble | 1.00 | 1.00 | 1.00 | 1.00 |
| dietary fiber | | | | |
| Pectin | 0.08 | 0.08 | 0.08 | 0.08 |
| Concentrated | 5.00 | 5.00 | 5.00 | 5.00 |
| fruit juice | | | | |
| Lactobacillus | 0.02 | 0.02 | 0.02 | 0.02 |
| Congener | 0.05 | 0.05 | 0.05 | 0.05 |

TABLE 28

| | Comparative | Comparative | Experimental | Experimental | Experimental |
|---|---|---|---|---|---|
| | Example 5-10 | Example 5-12 | Example 5-21 | Example 5-22 | Example 5-23 |
| Overall preference | 2.3 ± 0.5 | 2.0 ± 0.5 | 2.8 ± 0.6* | 3.7 ± 0.5* | 3.5 ± 0.5* |
| Sweetness preference | 2.3 ± 0.3 | 2.7 ± 0.6 | 2.8 ± 0.4* | 3.6 ± 0.6* | 3.2 ± 0.7* |
| Intensity of sweetness | 2.6 ± 0.5 | 3.6 ± 0.5 | 3.0 ± 0.7 | 3.5 ± 0.7* | 3.8 ± 0.5* |
| Sourness preference | 2.3 ± 0.6 | 2.2 ± 0.6 | 2.9 ± 0.5* | 3.6 ± 0.5* | 3.3 ± 0.6* |
| Aftertaste preference | 2.5 ± 0.4 | 2.2 ± 0.6 | 3.0 ± 0.5* | 3.8 ± 0.6* | 3.5 ± 0.5* |
| | Comparative | Comparative | Experimental | Experimental | Experimental |
| | Example 5-11 | Example 5-12 | Example 5-24 | Example 5-25 | Example 5-26 |
| Overall preference | 2.1 ± 0.4 | 2.2 ± 0.4 | 2.7 ± 0.7* | 3.1 ± 0.5* | 3.5 ± 0.6* |
| Sweetness preference | 1.7 ± 0.4 | 2.8 ± 0.6 | 2.5 ± 0.7* | 3.2 ± 0.5* | 3.5 ± 0.6* |
| Intensity of sweetness | 2.1 ± 0.4 | 3.5 ± 0.5 | 2.6 ± 0.5* | 3.0 ± 0.5* | 3.5 ± 0.6* |
| Sourness preference | 2.3 ± 0.6 | 2.3 ± 0.5 | 2.5 ± 0.4 | 3.1 ± 0.5* | 3.6 ± 0.4* |
| Aftertaste preference | 2.2 ± 0.3 | 2.2 ± 0.6 | 2.8 ± 0.4* | 3.3 ± 0.4* | 3.6 ± 0.4* |

In Table 28, * indicates statistical significance.

As a result of the sensory evaluation, it was confirmed that the fermented milk samples prepared using the sweeteners obtained by applying allulose to oligosaccharide were remarkably increased in intensity of sweet taste, sweetness preference and were also enhanced in sourness and aftertaste preference, thereby exhibiting considerably improved overall preference.

### 5-5. Other Foods

Sweeteners with allulose applied to oligosaccharides were prepared in the same manner as in Example 1 such that weight ratio of allulose to oligosaccharide was 4.24 (Experimental Example 5-27: fructooligosaccharide was used as oligosaccharide, Experimental Example 5-28: isomaltooligosaccharide was used as oligosaccharide), and were used for home cooking, followed by sensory evaluation. Results are shown in Table 29.

Specifically, fructooligosaccharide (Comparative Example 1), allulose (Comparative Example 3), and Experimental Example 5-27 were provided to 15 ordinary housewife panelists in their 30s to 40s, and were subjected to sensory evaluation after being used for general cooking at home. Here, the sweeteners were each placed in a transparent plastic container, numbered with a random number plate without a separate label, and provided together with a sensory questionnaire.

In addition, isomaltooligosaccharide (Comparative Example 2), allulose (Comparative Example 3), and Experimental Example 5-28 were also provided to the same 15 housewife panelists, and sensory evaluation was conducted through the same procedure as above.

Common home cooked foods were prepared using the same ingredients but with different sweeteners by each panelist. Then, after eating the foods together with other family members, each panelist evaluated taste and preference of the foods on a 5-point scale. Here, at least two dishes were cooked so as to confirm versatility. The cooked dishes are as follows:

Potato stew, braised quail eggs, rice with beef, braised mackerel, soy sauce braised potatoes, stir-fried fish cake, seasoned raw vegetables, grilled squid, stir-fried rice cake, bulgogi, stir-fried eggplant, stir-fried anchovies, stir-fried squid, steamed chili, yellowish overripe cucumber salad, stir-fried vegetables, grilled rice cake (dressing), carbonated water (syrup), braised black beans, kiwi tea, baked flour (syrup), roasted ribs, soy sauce braised saury, shredded daikon, ssamjang, stir-fried beef, shaved ice with sweetened red beans (syrup), stir-fried dried squid, salad (dressing), and seasoned vegetables.

TABLE 29

| | Comparative | Comparative | Experimental | Comparative | Comparative | Experimental |
|---|---|---|---|---|---|---|
| | Example 1 | Example 3 | Example 5-27 | Example 2 | Example 3 | Example 5-28 |
| Overall preference | 3.1 ± 1.0 | 2.7 ± 1.1 | 4.0 ± 0.7* | 2.7 ± 0.9 | 2.5 ± 0.8 | 4.0 ± 0.5* |
| Sweetness preference | 3.1 ± 0.9 | 2.7 ± 1.1 | 3.7 ± 0.9* | 2.8 ± 0.9 | 2.5 ± 0.6 | 3.6 ± 0.6* |
| Aftertaste preference | 2.8 ± 0.8 | 2.0 ± 0.7 | 3.6 ± 0.7* | 2.3 ± 1.0 | 2.1 ± 0.8 | 3.4 ± 0.7* |

In Table 29, * indicates statistical significance.

As a result of sensory evaluation, it was confirmed that, regardless of the type of oligosaccharides, the sweetness preference, overall preference, and aftertaste preference of the foods using the sweeteners obtained by applying allulose to oligosaccharides (Experimental Example 5-27 and 5-28) were significantly higher (p<0.05).

Thus, it can be seen that the sweetener obtained by applying allulose to oligosaccharides according to the present application can significantly increase the sweetness intensity and preference of a food using the sweetener, as compared with typical oligosaccharide products used at home instead of sugar. Therefore, the sweetener according to the present application exhibits increased sweetness intensity while having low calorie content and thus can be applied to various foods and used as a substitute for sugar.

### Preparative Example 1: Preparation of Aerated Water

Liquid allulose (C J CheilJedang, 95% or more of allulose in terms of dried solid content) or sugar (C J CheilJedang, White Sugar) was added to purified water in amounts as listed in Table 30, followed by stirring for 30 minutes using a magnetic stirrer. After the resulting mixture was cooled to 5° C., a maximum amount of carbon dioxide was injected into 1 L of the cooled mixture using a carbon dioxide injector (Delight Soda Chef, including an injection container/Zahm & Nagel #9000-R PILOT PLANT), thereby preparing aerated water samples of Comparative Examples 2 to 6 and Examples 1 to 5. An aerated water sample of Comparative Example 1 was prepared by injecting carbon dioxide as in Comparative Examples 2 to 6 and Examples without addition of allulose or sugar. Each of the prepared aerated water samples was packed in a pressure resistant PET bottle, followed by sealing, and then stored in a refrigerator (at 5° C.).

TABLE 30

| | Purified | Allulose | Sugar |
|---|---|---|---|
| Item | water (wt %) | (dried solid, wt %) | (dried solid, wt %) |
| Comparative | 100.0 | 0 | 0 |
| Example 1 | | | |
| Comparative | 99.7 | — | 0.3 |
| Example 2 | | | |
| Comparative | 99.5 | — | 0.5 |
| Example 3 | | | |
| Comparative | 98.8 | — | 1.2 |
| Example 4 | | | |
| Comparative | 98.0 | — | 2.0 |
| Example 5 | | | |
| Comparative | 97.0 | — | 3.0 |
| Example 6 | | | |
| Example 1 | 99.7 | 0.3 | — |
| Example 2 | 99.5 | 0.5 | — |
| Example 3 | 98.8 | 1.2 | — |
| Example 4 | 98.0 | 2.0 | — |
| Example 5 | 97.0 | 3.0 | — |

### Experimental Example 1: Sensory Properties of Allulose-Containing Aerated Water

Sensory evaluation was performed on each of the samples of Examples 1 to 5 and Comparative Examples 1 to 6 by examining sensory properties (acridity, sweetness, overall preference) of each sample in 30 panel members. In sensory evaluation, each of the aerated water samples was poured into a tasting cup with a random number added thereto to get rid of preconceptions, followed by evaluation on a 9-point scale. Measurement results were statistically analyzed by analysis of variance (ANOVA) and then were post-tested by Duncan's multiple range test, thereby analyzing storage time-dependent significance.

As a result, it was confirmed that the aerated water samples of Examples 1 to 5 had sweetness similar to the aerated water samples of Comparative Examples 2 to 6 and exhibited significantly reduced off-taste/off flavor intensity and significantly enhanced refreshing sensation and overall preference. In addition, it was confirmed that the aerated water samples of Examples 1 to 5 had considerably reduced acridity, as compared with the aerated water sample of Comparative Example 1. Particularly, it was confirmed that the aerated water samples of Examples 3 to 5 had significantly reduced acridity, as compared with the aerated water samples of Comparative Example 4 to 6, prepared by adding sugar in the same amount as allulose (Tables 31 to 35).

TABLE 31
Sweetness intensity

| | Item | | |
|---|---|---|---|
| | Comparative Example 1 | Comparative Example 2 | Example 1 |
| Average | 0.97^{B} | 2.37^{A} | 2.4^{A} |
| | Item | | |
| | Comparative Example 1 | Comparative Example 3 | Example 2 |
| Average | 1.03^{B} | 2.7^{A} | 2.77^{A} |
| | Item | | |
| | Comparative Example 1 | Comparative Example 4 | Example 3 |
| Average | 0.93^{B} | 3.03^{A} | 3^{A} |
| | Item | | |
| | Comparative Example 1 | Comparative Example 5 | Example 4 |
| Average | 0.83^{B} | 4.03^{A} | 3.87^{A} |
| | Item | | |
| | Comparative Example 1 | Comparative Example 6 | Example 5 |
| Average | 0.77^{B} | 4.13^{A} | 3.93^{A} |

TABLE 32
Acridity intensity

| | Item | | |
|---|---|---|---|
| | Comparative Example 1 | Comparative Example 2 | Example 1 |
| Average | 6.03^{A} | 3.7^{B} | 3.17^{B} |
| | Item | | |
| | Comparative Example 1 | Comparative Example 3 | Example 2 |
| Average | 6.23^{A} | 4.03^{B} | 3.3^{B} |
| | Item | | |
| | Comparative Example 1 | Comparative Example 4 | Example 3 |
| Average | 6.3^{A} | 4.4^{B} | 3.33^{C} |
| | Item | | |
| | Comparative Example 1 | Comparative Example 5 | Example 4 |
| Average | 6.4^{A} | 4.47^{B} | 3.17^{C} |
| | Item | | |
| | Comparative Example 1 | Comparative Example 6 | Example 5 |
| Average | 6.5^{A} | 4.37^{B} | 3.07^{C} |

TABLE 33
Off-taste/off-flavor intensity

| | Item | | |
|---|---|---|---|
| | Comparative Example 1 | Comparative Example 2 | Example 1 |
| Average | 4.83^{A} | 4.73^{A} | 4.13^{B} |
| | Item | | |
| | Comparative Example 1 | Comparative Example 3 | Example 2 |
| Average | 4.97^{A} | 4.83^{A} | 4.23^{B} |
| | Item | | |
| | Comparative Example 1 | Comparative Example 4 | Example 3 |
| Average | 5.03^{A} | 4.97^{A} | 4.17^{B} |
| | Item | | |
| | Comparative Example 1 | Comparative Example 5 | Example 4 |
| Average | 5.07^{A} | 5.03^{A} | 3.97^{B} |
| | Item | | |
| | Comparative Example 1 | Comparative Example 6 | Example 5 |
| Average | 5.23^{A} | 5.17^{A} | 3.83^{B} |

TABLE 34
Refreshing sensation intensity

| | Item | | |
|---|---|---|---|
| | Comparative Example 1 | Comparative Example 2 | Example 1 |
| Average | 6.13^{B} | 5.87^{B} | 6.67^{A} |
| | Item | | |
| | Comparative Example 1 | Comparative Example 3 | Example 2 |
| Average | 6.13^{B} | 5.83^{B} | 6.77^{A} |
| | Item | | |
| | Comparative Example 1 | Comparative Example 4 | Example 3 |
| Average | 6.1^{B} | 5.73^{B} | 6.87^{A} |
| | Item | | |
| | Comparative Example 1 | Comparative Example 5 | Example 4 |
| Average | 5.93^{B} | 5.63^{B} | 6.97^{A} |
| | Item | | |
| | Comparative Example 1 | Comparative Example 6 | Example 5 |
| Average | 5.97^{B} | 5.67^{B} | 7.07^{A} |

TABLE 35
Overall preference

| | Item | | |
|---|---|---|---|
| | Comparative Example 1 | Comparative Example 2 | Example 1 |
| Average | 6.37^{BC} | 6.13^{C} | 6.7^{AB} |
| | Item | | |
| | Comparative Example 1 | Comparative Example 3 | Example 2 |
| Average | 6.03^{B} | 6.2^{B} | 6.8^{A} |
| | Item | | |
| | Comparative Example 1 | Comparative Example 4 | Example 3 |
| Average | 5.87^{B} | 6.1^{B} | 6.77^{A} |
| | Item | | |
| | Comparative Example 1 | Comparative Example 5 | Example 4 |
| Average | 5.73^{B} | 5.87^{B} | 6.77^{A} |
| | Item | | |
| | Comparative Example 1 | Comparative Example 6 | Example 5 |
| Average | 5.43^{B} | 5.9^{B} | 6.87^{A} |

※ Each of the letters (A, B, C) denotes a group of results on the same line and the presence of a different letter means that there is a significant difference (p<0.05).

### Experimental Example 2: Carbon Dioxide Solubility and Carbon Dioxide Pressure Retention Rate of Allulose-Containing Aerated Water

### 2-1. Carbon Dioxide Solubility

Initial carbon dioxide pressure of each of the aerated water samples of Examples 1 to 5 and Comparative Examples 1 to 6 prepared in Preparative Example 1 was measured to determine carbon dioxide solubility. Specifically, the initial carbon dioxide pressure was measured three times using a carbon dioxide pressure meter (Series 6000, Zahm & Nagel Co., Inc.) in accordance with the gas pressure test specified in the Korean Food Code (section 18-2. (1), 2016).

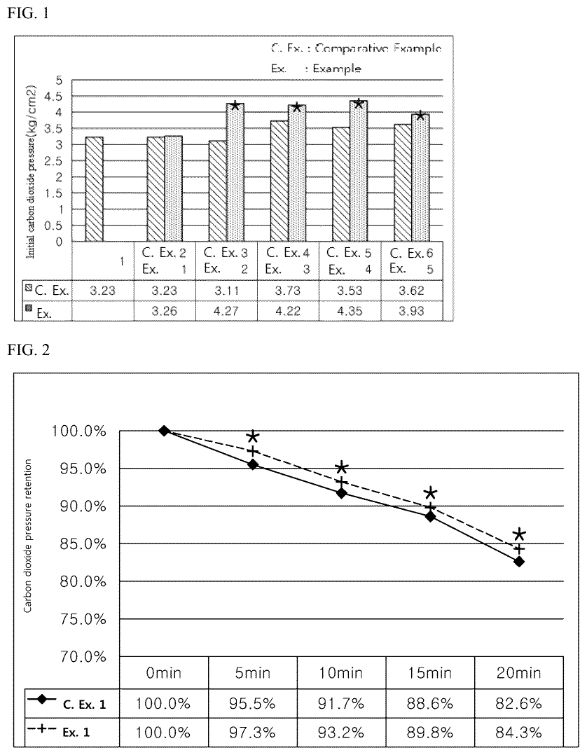

As a result, it was confirmed that the aerated water samples of Examples 2 to 5 had significantly high initial carbon dioxide pressure, as compared with the aerated water samples of Comparative Examples 1 to 6. Therefore, it can be seen that the allulose-containing aerated water according to the present disclosure exhibited higher carbon dioxide solubility than the aerated water sample free from saccharide (Comparative Example 1) and the aerated water samples prepared by adding sugar (Comparative Examples 2 to 6) (see FIG. 1).

### 2-2. Carbon Dioxide Pressure Retention

Carbon dioxide pressure of each of the samples was measured at predetermined points of time (after 5, 10, 15, and 20 minutes after preparation). Specifically, the carbon dioxide pressure was measured at 20° C. at each of the predetermined points of time while repeating a procedure in which, after the carbon dioxide pressure was measured once, carbon dioxide gas was removed from the aerated water by opening a snifter valve of the carbon dioxide pressure meter, and then the valve was closed such that carbon dioxide dissolved in the aerated water could be re-eluted to generate carbon dioxide pressure.

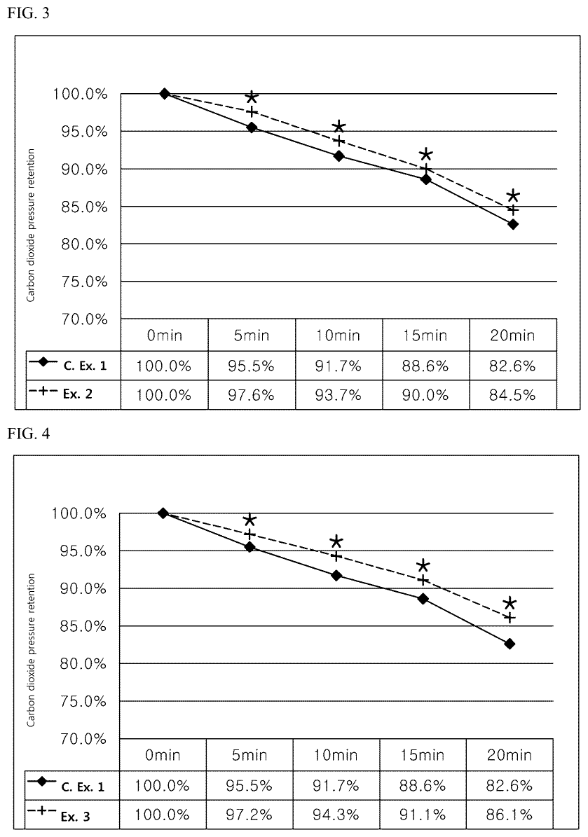

As a result, it was confirmed that the aerated water samples of Examples 1 to 5 exhibited significantly high carbon dioxide pressure retention, as compared with the aerated water samples of Comparative Examples 1 to 6. Therefore, it can be seen that addition of allulose to aerated water can prolong the time for which carbon dioxide was retained (captured) by the aerated water (see FIGS. 2 to 7).

### 1. Experimental Example 1: Manufacturing of Fermented Milk

Raw milk (97% (w/w)) and skim milk powder (3% (w/w)), which were raw materials, were mixed with each other at the above-mentioned mixing ratio at room temperature, stirred for 30 minutes, and sterilized at 90° C. for 10 minutes, and then cooled to 40° C. ABT-5 (Chr. Hansen, Denmark, hereinafter, referred to as ‘lactic acid bacteria’), which is a starter in which Lactobacillus acidophilus, Bifidobacterium lactis, and Streptococcus thermophilus are mixed with each other, was aseptically inoculated into the mixture, thereby preparing a lactic acid bacteria inoculum.

After the lactic acid bacteria inoculum was cultured in a 40° C. incubator (Jeio Tech IL-11 incubator, Korea) for 4 to 5 hours until pH thereof reached 4.6 and titratable acidity thereof reached in the vicinity of 0.9%, the curd was crushed and rapidly cooled to 20° C. or less, followed by homogenization (NiroSoavi NS2006H homogenizer, Italy) at a pressure of 150 bar, thereby preparing a lactic acid bacteria culture solution.

Separately from the lactic acid bacteria culture solution, a high fructose corn syrup (75 Brix; a mixture of fructose (55 wt %), glucose (41 wt %), and maltose (4 wt %); ‘High fructose corn syrup’ manufactured by Cheiljedang), 50% allulose-mixed sugar syrup [prepared by mixing allulose (72 Brix, allulose content: 98 wt % or more, ‘liquid allulose’ manufactured by Cheiljedang) and the ‘high fructose corn syrup’ with each other so that a dried solid content of allulose was 50 wt %], 60% allulose-mixed sugar syrup [prepared by mixing the ‘allulose’ and the ‘high fructose corn syrup’ with each other so that a dried solid content of allulose was 60 wt %], 70% allulose-mixed sugar syrup [prepared by mixing the ‘liquid allulose’ and the ‘high fructose corn syrup’ with each other so that a dried solid content of allulose was 70 wt %], 80% allulose-mixed sugar syrup [prepared by mixing the ‘allulose’ and the ‘high fructose corn syrup’ with each other so that a dried solid content of allulose was 80 wt %], and allulose syrup (the ‘liquid allulose’) were prepared, respectively (Table 36). Since allulose and the allulose-mixed sugar have sweetness lower than that of the high fructose corn syrup, sweetness was compensated for using rebaudioside A (RA) (RA content: 90 wt %, MacroCare Tech., Ltd.) as a natural high-intensity sweetener.

After each of the syrups was stirred at room temperature for 30 minutes, sterilized at 90° C. for 10 minutes, and cooled to 10° C. or less, respectively, the lactic acid bacteria culture solution and each of the syrups were mixed with each other at a weight ratio of 85:15, thereby completing the manufacturing of fermented milk.

TABLE 36
Mixing ratio of fermented milk

| | | Mixing ratio (wt %) | | | | | |
|---|---|---|---|---|---|---|---|
| | | Comparative | Example | Example | Example | Example | Example |
| Raw materials of fermented milk | | Example | 1 | 2 | 3 | 4 | 5 |
| Lactic acid bacteria | Raw milk 97 wt %, | 85 | 85 | 85 | 85 | 85 | 85 |
| culture solution(85) | Skim milk powder 3 wt %, ABT-5 | | | | | | |
| Syrup(15) | High fructose corn syrup | 10 | 4.9 | 3.88 | 2.86 | 1.84 | 0 |
| | (75Btrix, fructose 55 wt %, | | | | | | |
| | glucose 41 wt %, maltose, etc. 4 | | | | | | |
| | wt % | | | | | | |
| | Allulose | 0 | 5.1 | 6.12 | 7.14 | 8.16 | 10 |
| | (72Brix, allulose 98 wt %, | | | | | | |
| | fructose 2 wt %) | | | | | | |
| | Rebaudioside A | 0 | 0.01 | 0.012 | 0.014 | 0.016 | 0.02 |
| | (RA 90 wt %) | | | | | | |
| | Purified water | 5 | 4.99 | 4.988 | 4.986 | 4.984 | 4.98 |
| Sum | | 100 | 100 | 100 | 100 | 100 | 100 |
| Content in Syrup | Allulose | 0 | 49.98 | 59.98 | 69.97 | 79.36 | 98.00 |
| (dried solid | Glucose | 41 | 20.51 | 16.31 | 12.07 | 7.80 | 0.00 |
| content) | Fructose | 55 | 27.51 | 22.88 | 17.40 | 11.88 | 1.63 |

### 2. Experimental Example 2: Storage Test of Fermented Milk

Six kinds of fermented milk in Comparative Example and Examples 1 to 5 were filled in a plurality of sterilized vessels (200 mL/vessel) and cold-stored (Jeio Tech IL-11 incubator, Korea) at 7° C., thereby performing a storage test. Samples were extracted on day 0, 1, 3, 5, 7, 10, 14, 17, 21, 24, 28, 31, and 35 during a storage period, and measurement of pH, titratable acidity, and sourness through a sensory test for the samples was conducted. Further, the number of lactic acid bacteria was additionally measured on day 0, 3, 7, 10, 14, 17, 21, 24, 28, 31, and 35 during the storage period.

In the case in which the titratable acidity was 1.00% or more or a sourness score is 7 points or more based on a 9-point scale, sensory quality was deteriorated, and in the case in which the number of lactic acid bacteria is 10⁸ cfu/ml or less, the samples did not satisfy legal standards for thickened fermented milk according to ‘Processing Standards and Ingredient Specifications for Livestock Products (Korea)’, such that the date on which the samples were extracted, was determined to be unsuitable for securing a normal expiration date.

### 2-1. Measurement of pH Depending on Storage Period

A temperature of each of the extracted samples was adjusted to 20° C., and pH thereof was measured using a pH meter (Mettler-ToledoSevenCompact pH/Ion S220, U.S.).

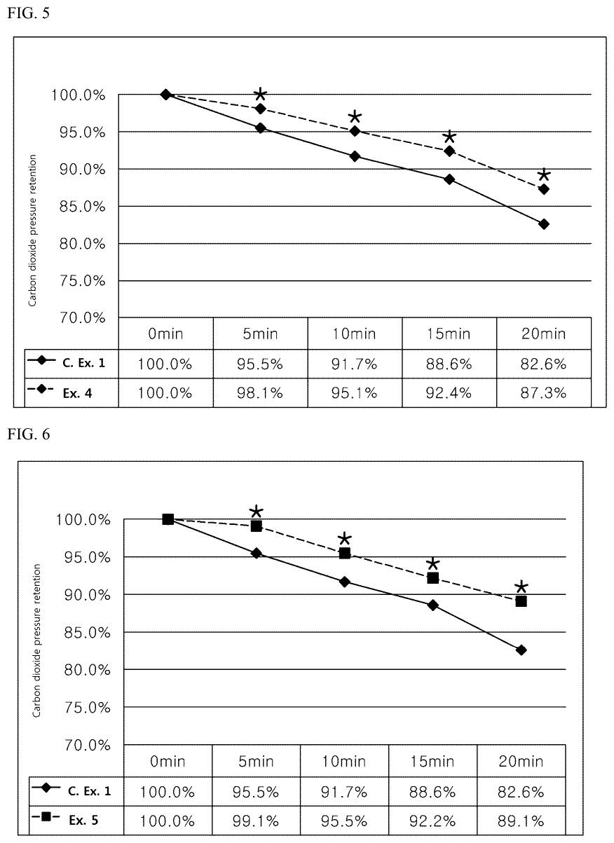

As a result, immediately after manufacturing the fermented milk, the pH of each of the samples was 4.5 to 4.6, but during cold-storage, the pH was gradually decreased. Therefore, it may be confirmed that in Comparative Example and Examples 1 and 2, pH was decreased to be less than 4.25 between day 10 to 14, corresponding to an expiration date of the existing fermented milk. But, in Example 3, the pH of 4.25 or more was maintained up to day 28 of cold-storage, in Example 4, and the pH of 4.25 or more was maintained up to day 31 of cold-storage, and in Example 5, the pH of 4.25 or more was maintained even up to day 35 of cold-storage (Table 38 and FIG. 8).

Therefore, it may be confirmed that the allulose had an effect of suppressing a decrease in pH during the cold-storage of the fermented milk, but in the cases of using the allulose-mixed sugar syrup in which the content of allulose was 60% or less (Examples 1 and 2) in the fermented milk, the effect was not large, but in the cases of using allulose-mixed sugar syrups in which the content of allulose was 70% or more in the fermented milk (Examples 3 to 5), the effect was significant.

### 2-2. Measurement of Titratable Acidity Depending on Storage Period

Titratable acidity was measured by extracting 9 g of a sample, mixing the sample with the same amount of carbon dioxide-free distilled water, stirring the mixture, and then titrating the mixture with 0.1N NaOH up to pH 8.3. Thus, a titration amount of NaOH was converted into acidity of lactic acid according to the following Equation.

$$Titratable acidity ( \% ) = \frac{0.1 N NaOH titration amount ( ml ) \times {0.009}^{*} \times {F}^{**}}{Sample weight ( g )} \times 100 \qquad 〈 Equation 1 〉$$

$${}^{*} 1 ml of 0.1 N NaOH corresponds to 0.009 g of lactic acid .$$

$${}^{**} Factor of 0.1 N NaOH$$

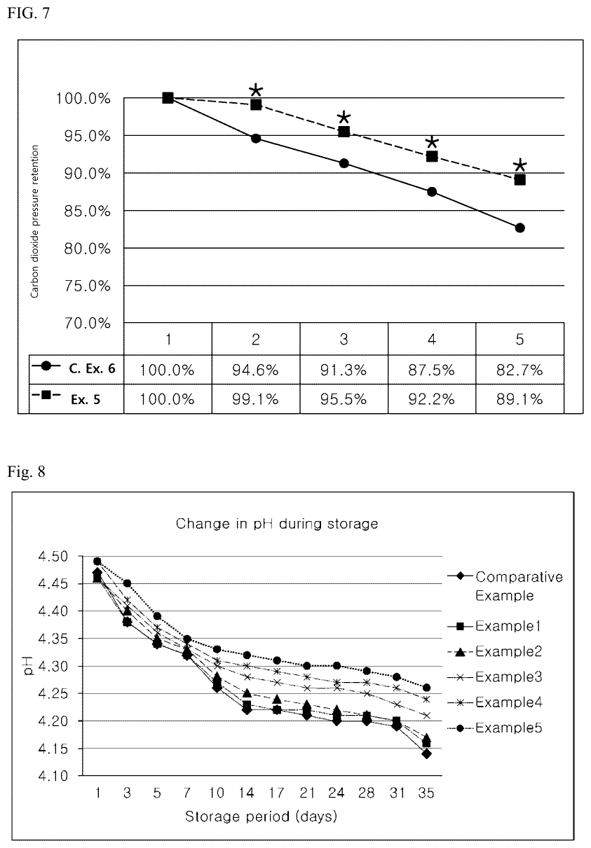

As a result, acidity that was about 0.8 immediately after manufacturing the fermented milk was gradually increased during cold-storage, such that in Comparative Example and Example 1, acidity arrived up to 1.00% on day 14 of cold-storage. Therefore, it was impossible to overcome a limitation of the existing fermented milk that an expiration date does not exceed 14 days, and acidity tended to be continuously increased depending on the storage period. In Example 2, acidity reached 1.00% on day 17 of cold-storage, such that an effect of extending the expiration date was not large. However, in Example 3, acidity did not reach 1.00% up to day 28 of cold-storage, and in Example 4, acidity did not reach 1.00% up to day 31 of cold-storage, and in Example 5, acidity did not reach 1.00% up to day 35 of cold-storage, and a change in acidity after 14 days tended to be significant small, which shows a possibility that the expiration date may be significantly increased (Table 38 and FIG. 9).

Therefore, it may be appreciated that allulose had an effect of suppressing an increase in acidity during the cold-storage of the fermented milk, but in the cases of using the allulose-mixed sugar syrup in which the content of allulose was 60% or less in the fermented milk (Examples 1 and 2), the effect was not large, but in the cases of using the allulose-mixed sugar syrups in which the content of allulose was 70% or more in the fermented milk (Examples 3 to 5), the effect was increased in proportion to the content of allulose.

### 2-3. Measurement of Sourness Depending on Storage Period

Sourness was measured through the sensory evaluation, and the sensory test was performed by a total of 10 trained panelists for the sensory test. The sensory test was performed by setting the following standard using a 9-point scale as illustrated in Table 37.

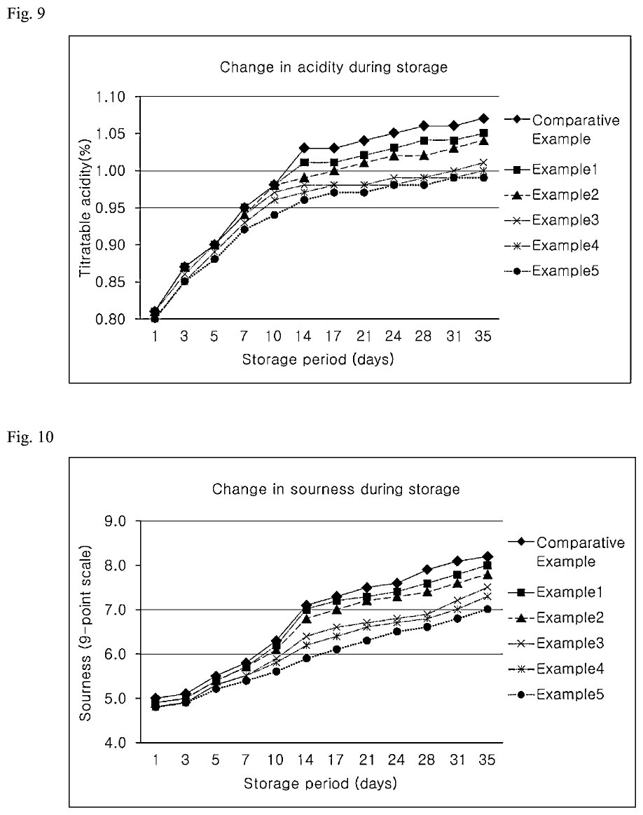

As a result, a sourness score that was the level of 5 points (moderately sour taste) immediately after manufacturing the fermented milk was gradually increased during cold-storage, such that in Comparative Example and Example 1, the sourness score reached up to 7 points (sour taste) on day 14 of cold-storage. Therefore, it was impossible to overcome a limitation of the existing fermented milk that an expiration date does not exceed 14 days, and sourness tended to be continuously increased even after 14 days. In Example 2, the sourness score reached 7 points on day 17 of cold-storage, such that an effect of extending the expiration date was not large. However, in Examples 3 and 4, the sourness score reached 7 points on day 31 of cold-storage, and in Example 5, the sourness score reached 7 points on day 35 of cold-storage, which shows a possibility that the expiration date may be significantly increased (Table 38 and FIG. 10).

Therefore, it may be appreciated that allulose had an effect of suppressing an increase in sourness during the cold-storage of the fermented milk, but in the cases of using the allulose-mixed sugar syrup in which the content of allulose was 60% or less in the fermented milk (Examples 1 and 2), the effect was not large, but in the cases of using allulose-mixed sugar syrups in which the content of allulose was 70% or more in the fermented milk (Examples 3 to 5), the effect was increased in proportion to the content of allulose.

### 2-4. Measurement of the Number of Lactic Acid Bacteria Depending on Storage Period

In order to measure the number of lactic acid bacteria, each of the samples was aseptically diluted with sterilized normal saline, and a BCP Plate count agar (Eiken Chemical, Japan) and a standard plate count method were used. The number of viable lactic acid bacteria was calculated by counting only yellow colonies after culturing the diluted samples at 37° C. for 72 hours (Jeio Tech IL-11 incubator, Korea) and multiplying a dilution factor and the counted number of yellow colonies.

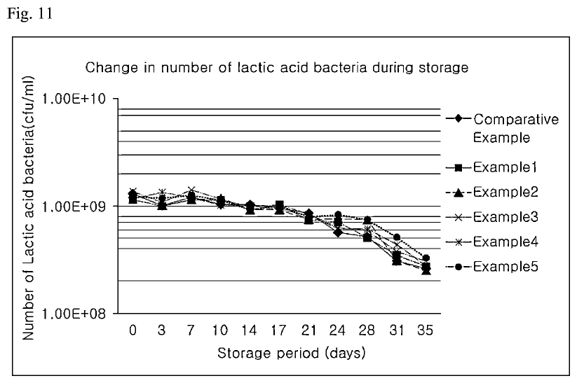

As a result, it was confirmed that in all Comparative Example and Examples, the number of lactic acid bacteria that was about 10⁹ cfu/ml immediately after manufacturing the fermented milk tended to be constantly maintained during cold-storage but be deceased after 17 days. However, the number of lactic acid bacteria was maintained to be 10⁸ cfu/ml or more up to day 35 of cold-storage. Therefore, it was confirmed that even though the allulose was added to the fermented milk, the expiration date was not decreased due to a decrease in the number of lactic acid bacteria (Table 38 and FIG. 11).

TABLE 38
Results of storage test of fermented milk

| Storage | | | Titratable | | Number of lactic | |
|---|---|---|---|---|---|---|
| period | | | acidity | Sourness | acid bacteria | |
| (7° C.) | Sample | pH | (%) | (9-point scale) | (cfu/ml) | Reference |
| Day 0 | Comparative | 4.60 | 0.79 | 4.9 | 1.31E+09 | |
| | Example | | | | | |
| | Example 1 | 4.55 | 0.79 | 4.8 | 1.15E+09 | |
| | Example 2 | 4.54 | 0.79 | 4.8 | 1.31E+09 | |
| | Example 3 | 4.53 | 0.78 | 4.8 | 1.38E+09 | |
| | Example 4 | 4.54 | 0.78 | | 1.15E+09 | |
| | Example 5 | 4.54 | 0.78 | 4.7 | 1.23E+09 | |
| Day 1 | Comparative | 4.47 | 0.81 | 5.0 | | |
| | Example | | | | | |
| | Example 1 | 4.46 | 0.81 | 4.9 | | |
| | Example 2 | 4.46 | 0.81 | 4.9 | | |
| | Example 3 | 4.46 | 0.81 | 4.8 | | |
| | Example 4 | 4.49 | 0.80 | 4.8 | | |
| | Example 5 | 4.49 | 0.80 | 4.8 | | |
| Day 3 | Comparative | 4.38 | 0.87 | 5.1 | 1.02E+09 | |
| | Example | | | | | |
| | Example 1 | 4.38 | 0.87 | 5.0 | 1.00E+09 | |
| | Example 2 | 4.40 | 0.87 | 5.0 | 1.01E+09 | |
| | Example 3 | 4.41 | 0.86 | 4.9 | 1.09E+09 | |
| | Example 4 | 4.42 | 0.85 | 4.9 | 1.34E+09 | |
| | Example 5 | 4.45 | 0.85 | 4.9 | 1.19E+09 | |
| Day 5 | Comparative | 4.34 | 0.90 | 5.5 | | |
| | Example | | | | | |
| | Example 1 | 4.34 | 0.90 | 5.4 | | |
| | Example 2 | 4.35 | 0.90 | 5.4 | | |
| | Example 3 | 4.36 | 0.90 | 5.3 | | |
| | Example 4 | 4.37 | 0.89 | 5.3 | | |
| | Example 5 | 4.39 | 0.88 | 5.2 | | |
| Day 7 | Comparative | 4.32 | 0.95 | 5.8 | 1.20E+09 | |
| | Example 1 | 4.32 | 0.95 | 5.7 | 1.14E+09 | |
| | Example 2 | 4.33 | 0.94 | 5.7 | 1.14E+09 | |
| | Example 3 | 4.33 | 0.94 | 5.5 | 1.41E+09 | |
| | Example 4 | 4.34 | 0.93 | 5.5 | 1.20E+09 | |
| | Example 5 | 4.35 | 0.92 | 5.4 | 1.26E+09 | |
| Day 10 | Comparative | 4.26 | 0.98 | 6.3 | 1.03E+09 | |
| | Example | | | | | |
| | Example 1 | 4.27 | 0.98 | 6.2 | 1.14E+09 | |
| | Example 2 | 4.28 | 0.98 | 6.1 | 1.19E+09 | |
| | Example 3 | 4.30 | 0.97 | 5.9 | 1.17E+09 | |
| | Example 4 | 4.31 | 0.96 | 5.8 | 1.02E+09 | |
| | Example 5 | 4.33 | 0.94 | 5.6 | 1.13E+09 | |
| Day 14 | Comparative | 4.22 | 1.03 | 7.1 | 1.02E+09 | Unsuitable |
| | Example | | | | | |
| | Example 1 | 4.23 | 1.01 | 7.0 | 1.00E+09 | Unsuitable |
| | Example 2 | 4.25 | 0.99 | 6.8 | 9.2E+08 | |
| | Example 3 | 4.28 | 0.98 | 6.4 | 9.3E+08 | |
| | Example 4 | 4.30 | 0.97 | 6.2 | 1.00E+09 | |
| | Example 5 | 4.32 | 0.96 | 5.9 | 9.2E+08 | |
| Day 17 | Comparative | 4.22 | 1.03 | 7.3 | 9.4E+08 | Unsuitable |
| | Example | | | | | |
| | Example 1 | 4.22 | 1.01 | 7.2 | 1.02E+09 | Unsuitable |
| | Example 2 | 4.24 | 1.00 | 7.0 | 9.3E+08 | Unsuitable |
| | Example 3 | 4.27 | 0.98 | 6.6 | 1.03E+09 | |
| | Example 4 | 4.29 | 0.98 | 6.4 | 9.4E+08 | |
| | Example 5 | 4.31 | 0.97 | 6.1 | 9.9E+08 | |
| Day 21 | Comparative | 4.21 | 1.04 | 7.5 | 8.6E+08 | Unsuitable |
| | Example | | | | | |
| | Example 1 | 4.22 | 1.02 | 7.3 | 7.4E+08 | Unsuitable |
| | Example 2 | 4.23 | 1.01 | 7.2 | 7.5E+08 | Unsuitable |
| | Example 3 | 4.26 | 0.98 | 6.7 | 8.5E+08 | |
| | Example 4 | 4.28 | 0.98 | 6.6 | 8.1E+08 | |
| | Example 5 | 4.30 | 0.97 | 6.3 | 8.0E+08 | |
| Day 24 | Comparative | 4.20 | 1.05 | 7.6 | 5.7E+08 | Unsuitable |
| | Example | | | | | |
| | Example 1 | 4.21 | 1.03 | 7.4 | 7.1E+08 | Unsuitable |
| | Example 2 | 4.22 | 1.02 | 7.3 | 7.6E+08 | Unsuitable |
| | Example 3 | 4.26 | 0.99 | 6.8 | 6.2E+08 | |
| | Example 4 | 4.27 | 0.98 | 6.7 | 6.1E+08 | |
| | Example 5 | 4.30 | 0.98 | 6.5 | 8.3E+08 | |
| Day 28 | Comparative | 4.20 | 1.06 | 7.9 | 5.2E+08 | Unsuitable |
| | Example | | | | | |
| | Example 1 | 4.21 | 1.04 | 7.6 | 5.1E+08 | Unsuitable |
| | Example 2 | 4.21 | 1.02 | 7.4 | 7.5E+08 | Unsuitable |
| | Example 3 | 4.25 | 0.99 | 6.9 | 6.0E+08 | |
| | Example 4 | 4.27 | 0.99 | 6.8 | 6.1E+08 | |
| | Example 5 | 4.29 | 0.98 | 6.6 | 7.5E+08 | |
| Day 31 | Comparative | 4.19 | 1.06 | 8.1 | 3.1E+08 | Unsuitable |
| | Example | | | | | |
| | Example 1 | 4.20 | 1.04 | 7.8 | 3.5E+08 | Unsuitable |
| | Example 2 | 4.20 | 1.03 | 7.6 | 3.1E+08 | Unsuitable |
| | Example 3 | 4.23 | 1.00 | 7.2 | 3.8E+08 | Unsuitable |
| | Example 4 | 4.26 | 0.99 | 7.0 | 4.4E+08 | Unsuitable |
| | Example 5 | 4.28 | 0.99 | 6.8 | 5.1E+08 | |
| Day 35 | Comparative | 4.14 | 1.07 | 8.2 | 2.60E+08 | Unsuitable |
| | Example | | | | | |
| | Example 1 | 4.16 | 1.05 | 8.0 | 2.75E+08 | Unsuitable |
| | Example 2 | 4.17 | 1.04 | 7.8 | 2.51E+08 | Unsuitable |
| | Example 3 | 4.21 | 1.01 | 7.5 | 3.10E+08 | Unsuitable |
| | Example 4 | 4.24 | 1.00 | 7.3 | 2.78E+08 | Unsuitable |
| | Example 5 | 4.26 | 0.99 | 7.0 | 3.29E+08 | Unsuitable |

Taking the results of the storage test together, in Comparative Example in which the high-fructose corn syrup generally used in the existing art was used as saccharides added to the fermented milk and in Example 1 in which the 50% allulose-mixed sugar syrup was used as saccharides added to the fermented milk, the acidity reached 1.00% and the sourness score reached 7 points on day 14 of cold-storage. Therefore, it was impossible to overcome a limitation of the existing fermented milk that an expiration date does not exceed 14 days. Further, in Example 2 in which the 60% allulose-mixed sugar syrup was used, the acidity reached 1.00% and the sourness score reached 7 points on day 17 of cold-storage, such that an effect of extending an expiration date of the fermented milk was insufficient. On the contrary, in Example 3 in which the 70% allulose-mixed sugar syrup was used as the saccharides of the fermented milk and in Example 4 in which the 80% allulose-mixed sugar syrup was used as the saccharides of the fermented milk, the acidity did not reach 1.00% and the sourness score did not reach 7 points, up to day 28 of cold-storage. Also, in Example 5 in which only liquid allulose was used as saccharides of the fermented milk, the acidity did not reach 1.00% and the sourness score did not reach 7 points, up to day 31 of cold-storage. Therefore, it may be appreciated that in the case of using saccharides in which a dried solid content of allulose is 70 wt % or more in fermented milk, the expiration date may be extended two times or more than 14 days in the existing art.

### 3. Experimental Example 3: Evaluation of Growth Inhibition Activity of Allulose Against Lactic Acid Bacteria

In order to confirm whether or not allulose may inhibit growth of other lactic acid bacteria except for lactic acid bacteria contained in the ABT-5, and then suppress lactic acid fermentation, a culture experiment was conducted on 18 kinds of representative lactic acid bacteria.

A minimal medium was prepared to have a composition illustrated in the following Table 39 and sterilized at 121° C. for 15 minutes (Jeio Tech AC-13 autoclave, Korea). Separately, glucose and allulose were dissolved in distilled water, respectively, to prepare a 50% (w/v) glucose solution and a 50% (w/v) allulose solution, respectively, and then filtered using a 0.45 μm micro-filter (Pall Life Sciences Acrodisc syringe filter, U.S.A.). Then, each of the 50% (w/v) glucose solution and the 50% (w/v) allulose solution was mixed with the sterilized minimal medium at a ratio of 4:96, thereby preparing a glucose medium and an allulose medium.

TABLE 39
Composition of minimal medium

| | Addition | |
|---|---|---|
| Composition of medium | amount (/L) | |
| Peptone | 10 | g |
| Sodium Acetate 3H₂O | 5 | g |
| Diammonium Citrate | 2 | g |
| Dipotassium Phosphate | 2 | g |
| Tween 80 | 10 | mL |
| Magnesium Sulfate 7H₂O | 1 | mL |
| Manganese Sulfate 4H₂O | 1 | mL |

18 kinds of representative lactic acid bacteria (Table 40) were selected, inoculated into the glucose medium and the allulose medium, respectively, and cultured in a 37° C. incubator (Jeio Tech IL-11 incubator, Korea). Then, samples were extracted at predetermined times (0, 3, 6, 9, 12, 24, and 48 hours), and an absorbance thereof was measured at 600 nm (Hitachi U-2900 spectrophotometer, Japan).

As a result, in the glucose medium, all the 18 kinds of lactic acid bacteria normally grew, but in the allulose medium, all the 18 kinds of lactic acid bacteria did not normally grow, such that the absorbance was not increased (Table 40). Therefore, it may be appreciated that the allulose may suppress growth of the 18 kinds of lactic acid bacteria, and have an effect of extending an expiration date by suppressing lactic acid post-fermentation due to suppressing the growth, in fermented milk manufactured using the culture solutions obtained by culturing the 18 kinds of lactic acid bacteria.

TABLE 40
Evaluation result of allulose utilization ability of lactic acid bacteria

| Lactobacillus acidophilus A | | | Leuconostoc mesenteroides | | | Lactobacillus gasseri | | |
|---|---|---|---|---|---|---|---|---|
| 37° C. | Glucose | Allulose | 37° C. | Glucose | Allulose | 37° C. | Glucose | Allulose |
| 0 h | 0.106 | 0.073 | 0 h | 0.104 | 0.081 | 0 h | 0.086 | 0.076 |
| 3 h | 0.153 | 0.086 | 3 h | 0.321 | 0.084 | 3 h | 0.152 | 0.083 |
| 6 h | 0.184 | 0.078 | 6 h | 0.988 | 0.084 | 6 h | 0.249 | 0.085 |
| 9 h | 0.210 | 0.068 | 9 h | 1.191 | 0.084 | 9 h | 0.332 | 0.105 |
| 12 h | 0.274 | 0.086 | 12 h | 1.445 | 0.095 | 12 h | 0.467 | 0.090 |
| 24 h | 0.322 | 0.067 | 24 h | 1.532 | 0.062 | 24 h | 0.724 | 0.071 |
| 48 h | 0.327 | 0.070 | 48 h | 1.469 | 0.078 | 48 h | 0.772 | 0.050 |

| Lactobacillus delbrueckii | | | Lactobacillus acidophilus B | | | Lactobacillus rhamnosus GG | | |
|---|---|---|---|---|---|---|---|---|
| 37° C. | Glucose | Allulose | 37° C. | Glucose | Allulose | 37° C. | Glucose | Allulose |
| 0 h | 0.082 | 0.075 | 0 h | 0.085 | 0.070 | 0 h | 0.085 | 0.080 |
| 3 h | 0.116 | 0.089 | 3 h | 0.114 | 0.088 | 3 h | 0.139 | 0.089 |
| 6 h | 0.168 | 0.089 | 6 h | 0.160 | 0.070 | 6 h | 0.348 | 0.091 |
| 9 h | 0.220 | 0.086 | 9 h | 0.194 | 0.078 | 9 h | 0.502 | 0.091 |
| 12 h | 0.279 | 0.098 | 12 h | 0.265 | 0.094 | 12 h | 0.678 | 0.099 |
| 24 h | 0.290 | 0.080 | 24 h | 0.276 | 0.072 | 24 h | 0.764 | 0.087 |
| 48 h | 0.231 | 0.082 | 48 h | 0.221 | 0.076 | 48 h | 0.744 | 0.088 |

| Lactobacillus acidophilus C | | | Lactobacillus casei A | | | Lactobacillus brevis | | |
|---|---|---|---|---|---|---|---|---|
| 37° C. | Glucose | Allulose | 37° C. | Glucose | Allulose | 37° C. | Glucose | Allulose |
| 0 h | 0.063 | 0.081 | 0 h | 0.075 | 0.081 | 0 h | 0.065 | 0.067 |
| 3 h | 0.092 | 0.089 | 3 h | 0.259 | 0.101 | 3 h | 0.168 | 0.075 |
| 6 h | 0.133 | 0.091 | 6 h | 0.283 | 0.127 | 6 h | 0.394 | 0.074 |
| 9 h | 0.179 | 0.091 | 9 h | 0.397 | 0.141 | 9 h | 0.523 | 0.075 |
| 12 h | 0.218 | 0.098 | 12 h | 0.693 | 0.149 | 12 h | 0.691 | 0.080 |
| 24 h | 0.262 | 0.079 | 24 h | 1.164 | 0.122 | 24 h | 0.931 | 0.060 |
| 48 h | 0.184 | 0.072 | 48 h | 1.228 | 0.139 | 48 h | 0.910 | 0.052 |
| Lactobacillus acidophilus D | | | Lactobacillus acidophilus E | | | Lactobacillus acidophilus F | | |
| 37° C. | Glucose | Allulose | 37° C. | Glucose | Allulose | 37° C. | Glucose | Allulose |
| 0 h | 0.083 | 0.091 | 0 h | 0.085 | 0.102 | 0 h | 0.080 | 0.086 |
| 3 h | 0.227 | 0.109 | 3 h | 0.254 | 0.119 | 3 h | 0.186 | 0.103 |
| 6 h | 0.996 | 0.120 | 6 h | 0.433 | 0.116 | 6 h | 0.268 | 0.118 |
| 9 h | 1.213 | 0.119 | 9 h | 0.501 | 0.138 | 9 h | 0.332 | 0.132 |
| 12 h | 1.428 | 0.154 | 12 h | 0.610 | 0.174 | 12 h | 0.477 | 0.143 |
| 24 h | 1.554 | 0.121 | 24 h | 0.521 | 0.134 | 24 h | 0.626 | 0.108 |
| 48 h | 1.493 | 0.109 | 48 h | 0.626 | 0.115 | 48 h | 0.922 | 0.088 |
| Lactobacillus acidophilus G | | | Lactobacillus salivarius | | | Lactobacillus plantarum | | |
| 37° C. | Glucose | Allulose | 37° C. | Glucose | Allulose | 37° C. | Glucose | Allulose |
| 0 h | 0.084 | 0.093 | 0 h | 0.087 | 0.117 | 0 h | 0.099 | 0.095 |
| 3 h | 0.147 | 0.097 | 3 h | 0.158 | 0.092 | 3 h | 0.215 | 0.097 |
| 6 h | 0.288 | 0.092 | 6 h | 0.338 | 0.122 | 6 h | 0.992 | 0.091 |
| 9 h | 0.327 | 0.091 | 9 h | 0.365 | 0.115 | 9 h | 1.198 | 0.096 |
| 12 h | 0.333 | 0.099 | 12 h | 0.396 | 0.131 | 12 h | 1.399 | 0.110 |
| 24 h | 0.275 | 0.078 | 24 h | 0.376 | 0.095 | 24 h | 1.517 | 0.093 |
| 48 h | 0.234 | 0.077 | 48 h | 0.314 | 0.096 | 48 h | 1.460 | 0.095 |
| Lactobacillus casei B | | | Lactobacillus acidophilus H | | | Lactobacillus acidophilus I | | |
| 37° C. | Glucose | Allulose | 37° C. | Glucose | Allulose | 37° C. | Glucose | Allulose |
| 0 h | 0.083 | 0.098 | 0 h | 0.088 | 0.096 | 0 h | 0.070 | 0.074 |
| 3 h | 0.138 | 0.099 | 3 h | 0.145 | 0.097 | 3 h | 0.179 | 0.092 |
| 6 h | 0.362 | 0.099 | 6 h | 0.306 | 0.094 | 6 h | 0.136 | 0.089 |
| 9 h | 0.405 | 0.095 | 9 h | 0.375 | 0.092 | 9 h | 0.176 | 0.088 |
| 12 h | 0.407 | 0.101 | 12 h | 0.412 | 0.097 | 12 h | 0.226 | 0.097 |
| 24 h | 0.378 | 0.086 | 24 h | 0.437 | 0.080 | 24 h | 0.265 | 0.073 |
| 48 h | 0.269 | 0.074 | 48 h | 0.396 | 0.090 | 48 h | 0.173 | 0.070 |

In some embodiments, the present disclosure relates to the following embodiments.
Embodiment 1. A beverage comprising water, an amino acid, and allulose.
Embodiment 2. The beverage of embodiment 1, wherein the amino acid is one or more amino acids selected from the group consisting of L-arginine, L-methionine, L-omithine, and L-citrulline.
Embodiment 3. The beverage of embodiment 3, wherein 3 to 11 parts by weight of the allulose is contained based on 100 parts by weight of the beverage, based on dry solids.
Embodiment 4. The beverage of embodiment 1, wherein the amino acid and allulose are contained at a ratio of 1:30 to 1:110, based on dry solids.
Embodiment 5. The beverage of embodiment 1, wherein 0.6 or less parts by weight of fructose is additionally included based on 100 parts by weight of the beverage, based on dry solids. Embodiment 6. The beverage of embodiment 1, wherein sucrose, glucose, or the combination of thereof, is not contained.
Embodiment 7. The beverage of embodiment 1, wherein the pH is in a range of 3.0 to 5.0.
Embodiment 8. The beverage of embodiment 1, wherein the acidity is in a range of 0.05 to 0.2.
Embodiment 9. A method for reducing an off-taste, an off-odor, or an acrid taste of a beverage containing an amino acid, comprising a step of mixing water, the amino acid, and allulose.
Embodiment 10. The method of embodiment 9, wherein 3 to 11 parts by weight of the allulose is mixed based on 100 parts by weight of the beverage containing an amino acid, based on dry solids.
Embodiment 11. The method of embodiment 9, wherein the amino acid and allulose are mixed at a ratio of 1:30 to 1:110, based on dry solids.
Embodiment 12. The method of embodiment 9, wherein a step of mixing one or more saccharides selected from the group consisting of glucose, sucrose, or the combination thereof is not included.

In some embodiments, the present disclosure relates to the following additional embodiments.
Embodiment 1. A sweetener comprising allulose and oligosaccharide, wherein the sweetener has an increase in acid resistance of the oligosaccharide.
Embodiment 2. The sweetener according to embodiment 1, wherein the sweetener has acid resistance at pH 1 to 6.
Embodiment 3. The sweetener according to embodiment 1, wherein the sweetener has 90 wt % or more oligosaccharide as measured after 24 hours of storage at pH 2, based on oligosaccharide weight at 0 hours of storage under the same conditions.
Embodiment 4. The sweetener according to embodiment 1, wherein the sweetener has 80 wt % or more oligosaccharide as measured after 48 hours of storage at pH 2, based on oligosaccharide weight at 0 hours of storage under the same conditions.
Embodiment 5. The sweetener according to embodiment 1, wherein the sweetener has further an increase in heat resistance of the oligosaccharide.
Embodiment 6. The sweetener according to embodiment 5, wherein the sweetener has heat resistance at 20° C. to 90° C.
Embodiment 7. The sweetener according to embodiment 1, wherein the sweetener has 30 wt % or more oligosaccharide as measured after 2 hours of storage at pH 2 and 85° C., based on oligosaccharide weight at 0 hours of storage under the same conditions.
Embodiment 8. The sweetener according to embodiment 1, wherein the sweetener has 10 wt° 0 or more oligosaccharide as measured after 4 hours of storage at pH 2 and 85° C., based on oligosaccharide weight at 0 hours of storage under the same conditions.
Embodiment 9. The sweetener according to embodiment 1, wherein the allulose is present in an amount of 20 parts by weight to 1,000 parts by weight relative to 100 parts by weight of the oligosaccharide.
Embodiment 10. The sweetener according to embodiment 1, wherein the oligosaccharide is fructooligosaccharide.
Embodiment 11. The sweetener according to embodiment 1, wherein the sweetener is further improved in taste.
Embodiment 12. The sweetener according to embodiment 11, wherein the improvement in taste is an increase in sweetness.
Embodiment 13. The sweetener according to embodiment 1, wherein the sweetener further comprises a salt.
Embodiment 14. The sweetener according to embodiment 13, wherein the salt comprises citrates, lactates, carbonates, phosphates, or combinations thereof.
Embodiment 15. The sweetener according to embodiment 13, wherein the salt is sodium citrate, sodium lactate, sodium hydrogen carbonate, or trisodium phosphate.
Embodiment 16. The sweetener according to embodiment 13, wherein the salt is present in an amount of 0.05 parts by weight to 0.5 parts by weight relative to 100 parts by weight of the sweetener.
Embodiment 17. A method of increasing acid resistance of an oligosaccharide of an oligosaccharide-containing sweetener, comprising: applying allulose to the oligosaccharide.
Embodiment 18. The method according to embodiment 17, wherein the method further increase heat resistance of the oligosaccharide.
Embodiment 19. The method according to embodiment 17, wherein the allulose is applied in an amount of 20 parts by weight to 1,000 parts by weight relative to 100 parts by weight of the oligosaccharide.
Embodiment 20. The method according to embodiment 17, further comprising: applying a salt to the oligosaccharide before, after, or simultaneously with applying the allulose to the oligosaccharide.
Embodiment 21. The method according to embodiment 17, wherein the salt is applied in an amount of 0.05 parts by weight to 0.5 parts by weight relative to 100 parts by weight of the sweetener.
Embodiment 22. The method according to embodiment 18, wherein the method further improve taste of the sweetener.
Embodiment 23. A food composition comprising the sweetener according to any one of embodiments 1 to 16.

In some embodiments, the present disclosure relates to the following additional embodiments.
Embodiment 1. An aerated water comprising water, carbonic acid and allulose.
Embodiment 2. The aerated water according to embodiment 1, wherein the aerated water is free from at least one selected from the group consisting of saccharides other than allulose, synthetic sweeteners, organic acids, edible pigments, caffeine, and preservatives.
Embodiment 3. The aerated water according to embodiment 1, wherein the allulose is present in an amount of 0.1 parts by weight to 5.0 parts by weight relative to 100 parts by weight of the aerated water.
Embodiment 4. The aerated water according to embodiment 1, wherein the aerated water has improved properties in terms of carbon dioxide solubility or carbon dioxide pressure retention.
Embodiment 5. The aerated water according to embodiment 1, wherein the aerated water has a carbon dioxide pressure of 2.5 kg/cm² to 4.5 kg/cm² at 20° C.
Embodiment 6. The aerated water according to embodiment 1, wherein the aerated water has a carbon dioxide pressure retention rate of 84% or more as measured after exposure to air at 20° C. for 20 minutes, compared to the carbon dioxide pressure at the time of exposure to air.
Embodiment 7. The aerated water according to embodiment 1, wherein the aerated water has improved taste.
Embodiment 8. The aerated water according to embodiment 1, wherein the improvement in taste is reduction in acridity, off-taste, or off-flavor.
Embodiment 9. A method of preparing an aerated water, comprising: (i) (a) adding allulose to water and (b) adding carbonic acid to the resulting product of the step (a); or (ii) adding allulose to water containing carbonic acid.
Embodiment 10. A method of improving taste of an aerated water, comprising: (i) (a) adding allulose to water and (b) adding carbonic acid to the resulting product of the step (a); or (ii) adding allulose to water containing carbonic acid.
Embodiment 11. A method of maintaining carbon dioxide pressure of an aerated water, comprising: (i) (a) adding allulose to water and (b) adding carbonic acid to the resulting product of the step (a); or (ii) adding allulose to water containing carbonic acid.
Embodiment 12. The method according to any one of embodiments 9 to 11, wherein the allulose is present in an amount of 0.1 parts by weight to 5.0 parts by weight relative to 100 parts by weight of the aerated water.

In some embodiments, the present disclosure relates to the following additional embodiments.
Embodiment 1. A fermented milk comprising saccharides comprising allulose, wherein the allulose is contained in an amount of 70 parts by weight or more, relative to 100 parts by weight of the saccharides in terms of dried solid content.
Embodiment 2. The fermented milk according to embodiment 1, wherein a difference in pH of the fermented milk at 7° C. after a date selected in 21 to 31 days from a manufacturing date, is 0.30 or less.
Embodiment 3. The fermented milk according to embodiment 1, wherein a difference in titratable acidity of the fermented milk is equal to or less than 0.20%, at 7° C. after a date selected in 17 to 28 days from a manufacturing date, as calculated according to the following Equation 1:

$$Titratable acidity ( \% ) = \frac{0.1 N NaOH titration amount ( ml ) \times {0.009}^{*} \times {F}^{**}}{Sample weight ( g )} \times 100 \qquad 〈 Equation 1 〉$$

$${}^{*} 1 ml of 0.1 N NaOH corresponds to 0.009 g of lactic acid .$$

$${}^{**} Factor of 0.1 N NaOH$$

Embodiment 4. The fermented milk according to embodiment 1, further comprising at least one kind of microorganisms selected from the group consisting of microorganisms of the genus Lactobacillus, microorganisms of the genus Bifidobacterium, and microorganisms of the genus Streptococcus.
Embodiment 5. The fermented milk according to embodiment 1, further comprising at least one kind of microorganisms selected from the group consisting of Lactobacillus acidophilus, Lactobacillus mesenteroides, Lactobacillus gasseri, Lactobacillus delbrueckii, Lactobacillus rhamnosus, Lactobacillus casei, Lactobacillus brevis, Lactobacillus salivarius, Lactobacillus plantarum, Bifidobacterium lactis, and Streptococcus thermophilus.
Embodiment 6. The fermented milk according to embodiment 1, wherein the saccharides include glucose in an amount of 15 parts by weight or less, relative to 100 parts by weight of the saccharides in terms of dried solid content.
Embodiment 7. The fermented milk according to embodiment 1, wherein the saccharides include fructose in an amount of 20 parts by weight or less, relative to 100 parts by weight of the saccharides in terms of dried solid content.
Embodiment 8. The fermented milk according to embodiment 1, wherein the saccharides are contained in an amount of 5 to 20 parts by weight, relative to 100 parts by weight of the fermented milk.
Embodiment 9. The fermented milk according to embodiment 1, further comprising milk in an amount of 80 to 95 parts by weight, relative to 100 parts by weight of the fermented milk.
Embodiment 10. A method of improving storability of fermented milk, the method comprising: adding saccharides comprising allulose to a lactic acid bacteria-culture product, wherein the allulose is contained in an amount of 70 parts by weight or more, relative to 100 parts by weight of the saccharides in terms of dried solid content.
Embodiment 11. The method according to embodiment 10, wherein the improvement of storability is caused by suppression of a decrease in pH, suppression of an increase in acidity, suppression of an increase in sourness, suppression of post-fermentation, or suppression of growth of microorganism.
Embodiment 12. The method according to embodiment 10, wherein the lactic acid bacteria are at least one kind of microorganisms selected from the group consisting of microorganisms of the genus Lactobacillus, microorganisms of the genus Bifidobacterium, and microorganisms of the genus Streptococcus.
Embodiment 13. A growth inhibitor for at least one kind of microorganisms selected from the group consisting of Lactobacillus acidophilus, Lactobacillus mesenteroides, Lactobacillus gasseri, Lactobacillus delbrueckii, Lactobacillus rhamnosus, Lactobacillus casei, Lactobacillus brevis, Lactobacillus salivarius, Lactobacillus plantarum, Bifidobacterium lactis, and Streptococcus thermophilus, the growth inhibitor comprising: saccharides comprising allulose.
Embodiment 14. The growth inhibitor according to embodiment 13, wherein the allulose is contained in an amount of 70 parts by weight or more, relative to 100 parts by weight of the saccharides in terms of dried solid content.

1. A composition comprising allulose.

2. The composition according to claim 1, wherein the composition is a beverage comprising water, an amino acid, and allulose.

3. The composition according to claim 1, wherein the composition is a sweetener comprising allulose and oligosaccharide, wherein the sweetener has an increase in acid resistance of the oligosaccharide.

4. The composition according to claim 1, wherein the composition is an aerated water comprising water, carbonic acid and allulose.

5. The composition according to claim 1, wherein the composition is a fermented milk comprising saccharides comprising allulose, wherein the allulose is contained in an amount of 70 parts by weight or more, relative to 100 parts by weight of the saccharides in terms of dried solid content.
